(19) United States
(12) Patent Application Publication
(10) Pub. No.: US 2015/0358546 A1
(43) Pub. Date: Dec. 10, 2015

(54) IMAGE PROCESSING APPARATUS, CONTROL METHOD, AND MEDIUM FOR COMPOSITING STILL PICTURES

(71) Applicant: CANON KABUSHIKI KAISHA, Tokyo (JP)

(72) Inventor: Teruyuki Higashiyama, Yokohama-shi (JP)

(21) Appl. No.: 14/732,411

(22) Filed: Jun. 5, 2015

(30) Foreign Application Priority Data
Jun. 10, 2014 (JP) 2014-120000

(51) Int. Cl. H04N 5/232; H04N 9/73; H04N 5/235

(52) U.S. Cl. CPC H04N 5/23277; H04N 5/23258; H04N 5/2352; H04N 9/735

(57) ABSTRACT

An image processing apparatus includes a detection unit configured to detect a blur of an image-capturing apparatus, a change in a subject brightness, or a change in a color of a subject, an image-capturing control unit configured to perform control so that the image-capturing apparatus performs image-capturing a plurality of times in accordance with a single image-capturing command, a composite unit configured to composite a plurality of images captured in accordance with the single image-capturing command, and a control unit configured such that when the control unit obtains information indicating that a predetermined blur, a change in a predetermined subject brightness, or a change in a color of a predetermined subject is detected based on a detection result, the control unit controls the composite unit so as to generate a composition image made by compositing a plurality of images captured before the detection.

### BACKGROUND OF THE INVENTION

1. Field of the Invention

The present disclosure generally relates to image processing, and more particularly, to an image processing apparatus, an image processing control method, and a medium for compositing still pictures obtained from a sequence of shooting.

2. Description of the Related Art

Image-capturing apparatuses such as a digital camera, a smartphone, and a tablet personal computer (PC) have methods for compositing a single composition image from multiple still pictures that are captured with a difference in timing of exposure. There is a method for causing a single image-capturing apparatus to continuously capture images to be composited, composite the captured still pictures, and record a track of starlit sky or the like.

Japanese Patent Application Laid-Open No. 2013-62740 discloses a method for compositing multiple still pictures captured with a predetermined interval by an image-capturing apparatus on every shooting (a method of interval composition).

In the shooting of starlit sky and the like, exposure is performed for many seconds, and a captured still picture may be blurred if the image-capturing unit moves even a little bit due to the effect of wind and the like, and when multiple images including a blurred image are composited, the composition image is also blurred. When a car enters into an image-capturing range, or a light of a light source outside of the image-capturing range enters into the image-capturing range, a subject other than a desired subject may enter into the composition image.

In the composition described in Japanese Patent Application Laid-Open No. 2013-62740, the composition is performed every time image-capturing process is performed, and therefore, when a change not desirable for the user such as a blur occurs, a composition image that is not acceptable to the user may be generated.

### SUMMARY OF THE INVENTION

The present disclosure provides an image processing apparatus that reduces the possibility of causing an effect in a composition image that is not acceptable to the user, even when a change not desirable for the user occurs in the course of the series of image-capturing process for capturing multiple images to be composited.

An aspect of the present disclosure provides an image processing apparatus including an obtaining unit configured to obtain information indicating detection of a blur of an image-capturing apparatus, a change in a subject brightness, or a change in a color of a subject; an image-capturing control unit configured to perform control so that the image-capturing apparatus performs image-capturing a plurality of times in accordance with a single image-capturing command; a composite unit configured to composite a plurality of images captured in accordance with the single image-capturing command; and a control unit configured such that when the control unit obtains information indicating that a predetermined blur, a change in a predetermined subject brightness, or a change in a color of a predetermined subject is detected based on a result obtained by the obtaining unit, the control unit controls the composite unit so as to generate a composition image made by compositing a plurality of images captured before the detection without including an image captured after the detection.

Further features of the present disclosure will become apparent from the following description of exemplary embodiments (with reference to the attached drawings).

### BRIEF DESCRIPTION OF THE DRAWINGS

FIG. 1 is a figure illustrating an example of a configuration of and an external appearance drawing of a digital camera.

FIG. 2 is a figure illustrating an example of a configuration of a digital camera.

FIGS. 3A to 3C are flowcharts illustrating starlit sky track image-capturing processing according to a first exemplary embodiment.

FIGS. 4A to 4C are a figure illustrating a data structure of an image file and a memory 32.

FIGS. 5A-1 to 5D-2 are figures illustrating an example of a captured image of a starlit sky track.

FIGS. 6A to 6C are flowcharts illustrating starlit sky track image-capturing processing according to a second exemplary embodiment.

FIGS. 7A to 7C are flowcharts illustrating starlit sky track image-capturing processing according to a third exemplary embodiment.

FIGS. 8A to 8C are flowcharts illustrating starlit sky track image-capturing processing according to a fourth exemplary embodiment.

### DESCRIPTION OF THE EMBODIMENTS

An exemplary embodiment of the present disclosure will be described in detail below with reference to the accompanying drawings.

It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment.

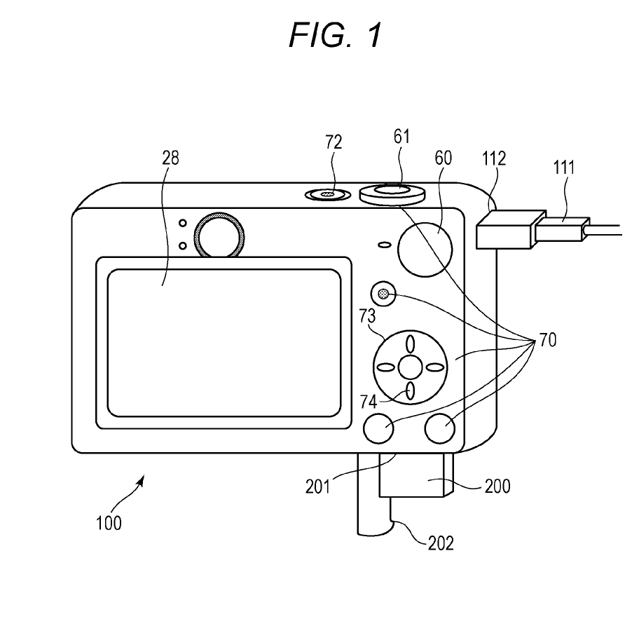

Hereinafter, exemplary embodiments for carrying out the present disclosure will be explained in details with reference to appended drawings. FIG. 1 illustrates an external appearance drawing of a digital camera which is an example of an image processing apparatus or image-capturing apparatus according to the present disclosure. A display unit 28 is a display unit displaying images and various kinds of information. A shutter button 61 is an operation unit for giving an image-capturing command. A mode selection switch 60 is an operation unit for switching various kinds of modes. A connector 112 is, for example, a connector for connecting with a digital camera 100 and a connection cable 111 for connecting with, for example, a PC and a printer. The operation unit 70 is an operation unit made of an operation member such as various kinds of switches, buttons, and touch panels receiving various kinds of operations from a user. A controller wheel 73 is a rotatable operation member included in the operation unit 70. The power supply switch 72 is a push button for switching a power supply ON state and a power supply OFF state. The recording medium 200 is a recording medium such as a memory card and a hard disk. A recording medium slot 201 is a slot for storing a recording medium 200. The recording medium 200 stored in the recording medium slot 201 is capable of communicating with the digital camera 100, and is capable of recording and play back. A lid 202 is a lid of the recording medium slot 201. The drawing shows that the lid 202 is opened, and a portion of the recording medium 200 is taken out and exposed from the recording medium slot 201. As used herein, the term “unit” generally refers to any combination of software, firmware, hardware, or other component, such as circuitry, that is used to effectuate a purpose.

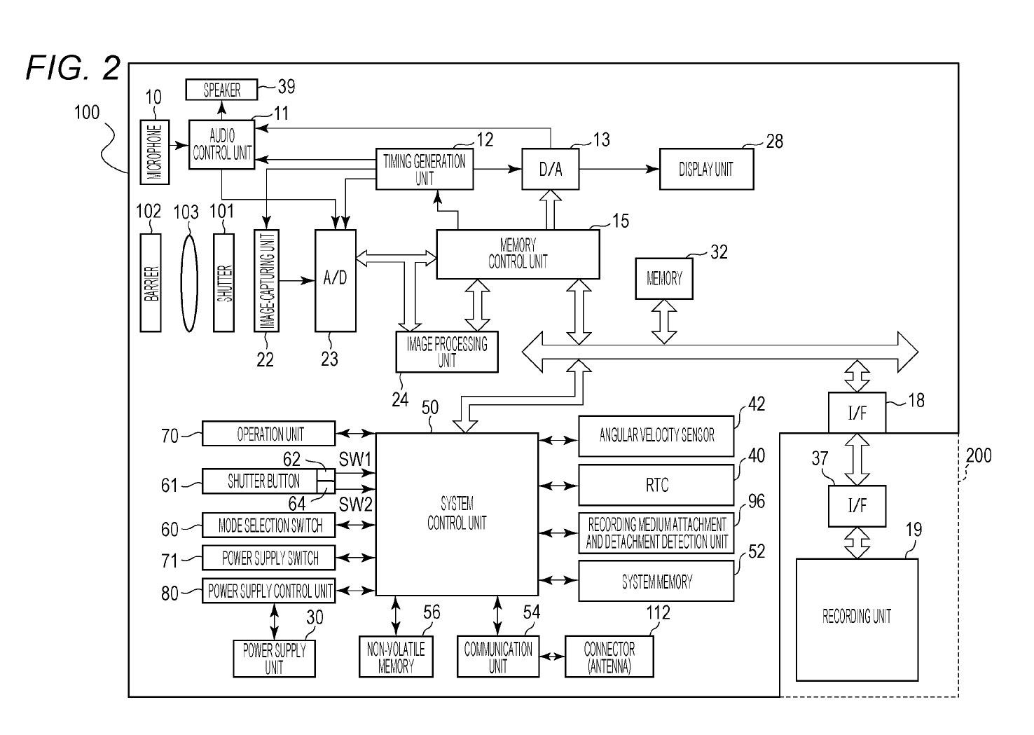

FIG. 2 is a block diagram illustrating an example of a configuration of a digital camera 100 according to the present exemplary embodiment.

In FIG. 2, an image-capturing lens 103 is a lens group including a zoom lens and a focus lens. A shutter 101 is a shutter having a diaphragm function. An image-capturing unit 22 is an image-capturing device constituted by a CCD (charge-coupled device), CMOS (complementary metal-oxide semiconductor) device, and the like for converting an optical image into an electric signal. An A/D (analog to digital) conversion device 23 converts an analog signal into a digital signal. The A/D conversion device 23 is used to convert an analog signal, which is output from the image-capturing unit 22, into a digital signal. A barrier 102 covers the image-capturing system including the image-capturing lens 103 in the digital camera 100, thus preventing the image-capturing system including the image-capturing lens 103, the shutter 101, and the image-capturing unit 22 from being polluted or damaged.

An image processing unit 24 performs color conversion processing and resize processing such as predetermined pixel interpolation and reduction on data given by the A/D conversion device 23 or data given by a memory control unit 15. The image processing unit 24 performs predetermined computation processing by using captured image data, and on the basis of obtained computation result, a system control unit 50 performs exposure control and distance measurement control. With the computation processing, the brightness of a subject and a color temperature (the color of the subject) can also be obtained. Therefore, TTL (through the lens) method AF (auto focus) processing, AE (auto exposure) processing, and EF (pre-flash) processing are performed. Further, the image processing unit 24 performs predetermined computation processing by using captured image data, and also performs TTL method AWB (auto white balance) processing on the basis of the obtained computation result.

The output data from the A/D conversion device 23 are directly written to the memory 32 via the image processing unit 24 and the memory control unit 15 or via the memory control unit 15. The memory 32 stores image data obtained by the image-capturing unit 22 and converted by the A/D conversion device 23 into digital data, and image data to be displayed on the display unit 28. The memory 32 has enough storage capacity to store a predetermined number of still images and motion image and audio for a predetermined time.

The memory 32 also serves as a memory for image display (video memory). A D/A conversion device 13 converts data for image display stored in the memory 32 into an analog signal and provides the analog signal to the display unit 28. As described above, the image data for display written to the memory 32 are displayed via the D/A (digital to analog) conversion device 13 by the display unit 28. The display unit 28 displays an image according to the analog signal given by the D/A conversion device 13 on a display device such as an LCD (liquid crystal display). The digital signal that is once A/D converted by the A/D conversion device 23 and accumulated in the memory 32 is converted into an analog signal by the D/A conversion device 13, and is successively transferred to the display unit 28 to be displayed, so that it can function as an electronic view finder, and can provide a through image display (live view display).

A nonvolatile memory 56 is a memory serving as an electrically erasable and recordable recording medium, and is, for example, made of an EEPROM (electrically erasable programmable read-only memory) and the like. The nonvolatile memory 56 stores constants for operation, programs, and the like of the system control unit 50. The program referred to herein means a computer program for executing various kinds of flowcharts explained later in each of the exemplary embodiments.

The system control unit 50 controls the entire digital camera 100. The system control unit 50 executes the program recorded in the nonvolatile memory 56 explained above, thus achieving the processing of each of the exemplary embodiments explained later.

The system memory 52 is made of a RAM. The constants for operation and programs for the system control unit 50, programs read from the nonvolatile memory 56, and the like are extracted to the system memory 52. The system control unit 50 controls the memory 32, the D/A conversion device 13, the display unit 28, and the like, thus performing display control.

RTC (Real Time Clock) 40 is a time count unit for measuring a time used for various kinds of controls and a time of a clock incorporated therein.

The mode selection switch 60, the shutter button 61, and the operation unit 70 are operation means for inputting various kinds of operation commands into the system control unit 50.

The mode selection switch 60 switches the operation mode of the system control unit 50 into any one of a still picture recording mode, a motion picture image-capturing mode, a play back mode, and the like. The modes included in the still picture recording mode include an auto image-capturing mode, an auto scene determination mode, a manual mode, various kinds of scene modes making image-capturing settings depending on image-capturing scenes, a program AE mode, a custom mode, and the like. The mode selection switch 60 can directly switch to any one of these modes included in the menu button. Alternatively, after switching to a menu button with the mode selection switch 60, the mode may be switched to any one of these modes included in the menu button by using another operation member. Likewise, the motion picture image-capturing mode may also include multiple modes. During operation of the shutter button 61 provided on the digital camera 100, i.e., so-called half-press (image-capturing preparation command), the first shutter switch 62 turns ON and generates a first shutter switch signal SW1. In response to the first shutter switch signal SW1, operation such as the AF (auto focus) processing, the AE (auto exposure) processing, the AWB (auto white balance) processing, the EF (pre-flash) processing, and the like is started.

Upon completion of operation of the shutter button 61, i.e., so-called full-press (image-capturing command), the second shutter switch 64 turns ON and generates a second shutter switch signal SW2. In response to the second shutter switch signal SW2, the system control unit 50 starts operation of a series of image-capturing processing from signal reading from the image-capturing unit 22 to writing of the image data to the recording medium 200.

An appropriate function is allocated, depending on scenes, to each operation member of the operation unit 70 by making selection operation of various function icons displayed on the display unit 28, and each operation member of the operation unit 70 acts as various kinds of function buttons. Examples of function buttons include a termination button, a back button, an image forward button, a jump button, a narrow down button, an attribute change button, and the like. For example, when a menu button is pressed, a menu screen capable of making various kinds of settings is displayed on the display unit 28. The user can intuitively make various kinds of settings by using the menu screen displayed on the display unit 28 and buttons of the arrow key 74 in four direction, which are up, down, right, and left directions, and a SET button.

The power supply control unit 80 includes a battery detection circuit, a DC-DC converter, a switch circuit for switching an energized block, and the like, and detects presence/absence of an attachment of a battery, the type of the battery, and the remaining amount of the battery. The power supply control unit 80 controls the DC-DC converter on the basis of the detection result and a command of the system control unit 50, and provides voltage to each unit including the recording medium 200 for a period of time.

The power supply unit 30 includes, e.g., a primary battery such as an alkaline battery and a lithium battery and a secondary battery such as a NiCd battery, a NiMH battery, and a Li battery, and an AC adapter. A recording medium I/F 18 is an interface provided at the side of the digital camera 100 and configured to connect with the recording medium 200 such as a memory card and a hard disk. A recording medium I/F 37 is an interface included in the recording medium 200 for a recording unit 19 and the digital camera 100. The recording medium 200 is a recording medium such as a memory card for recording a captured image, and is constituted by a semiconductor memory, an optical disk, a magnetic disk, and the like.

The communication unit 54 makes connection wirelessly or via a wired cable, and transmits and receives a video signal, an audio signal, and the like. The communication unit 54 can also connect to a wireless LAN (Local Area Network) and the Internet. The communication unit 54 can transmit an image captured by the image-capturing unit 22 (including a through image) and an image recorded in the recording medium 200, and can receive image data and various kinds of other information from an external device.

The angular velocity sensor 42 measures the angular velocity of the image-capturing unit 22 or the digital camera 100 including the image-capturing unit 22. By measuring the angular velocity, the degree of movement the image-capturing unit 22 can be found, and the degree of blur in a case where the image-capturing is performed can be found. In order to detect the motion of the image-capturing unit 22, sensors such as an acceleration sensor and an angular acceleration sensor can be used as long as they can detect movement of the image-capturing unit 22.

The timing generation unit 12 commands a point in time at which a function of audio, image-capturing, display and the like is activated. The audio control unit 11 controls the audio obtained from the microphone 10 and the audio generated by the speaker 39. The microphone 10 obtains audio in response to reception of a command for obtaining audio. The speaker 39 generates audio in response to reception of a command for generating audio.

### First Exemplary Embodiment

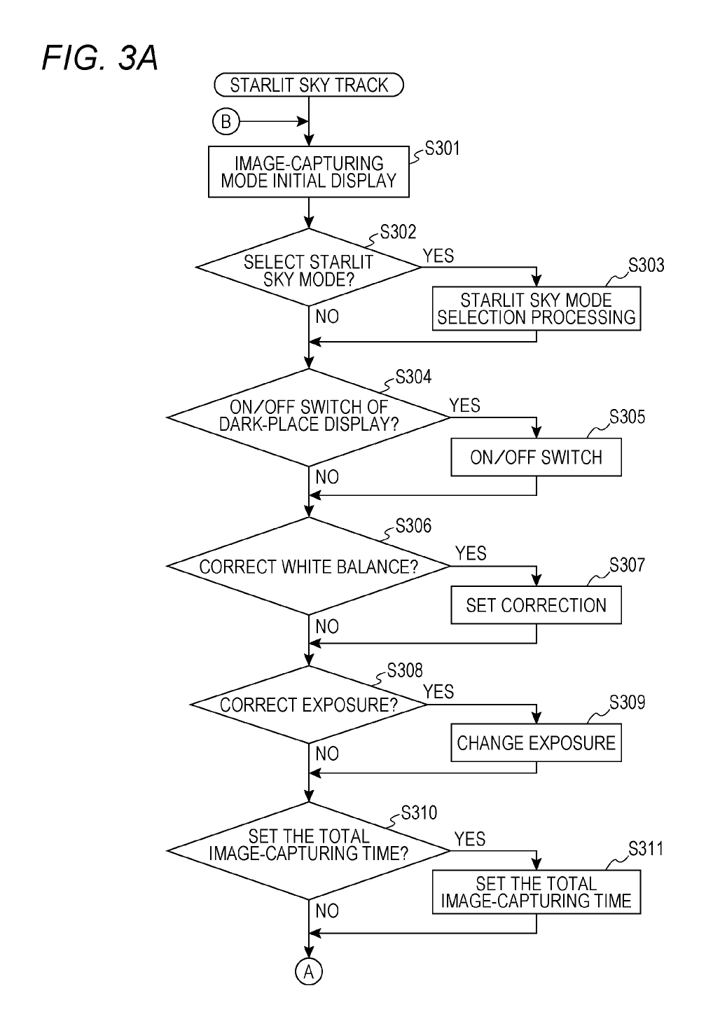

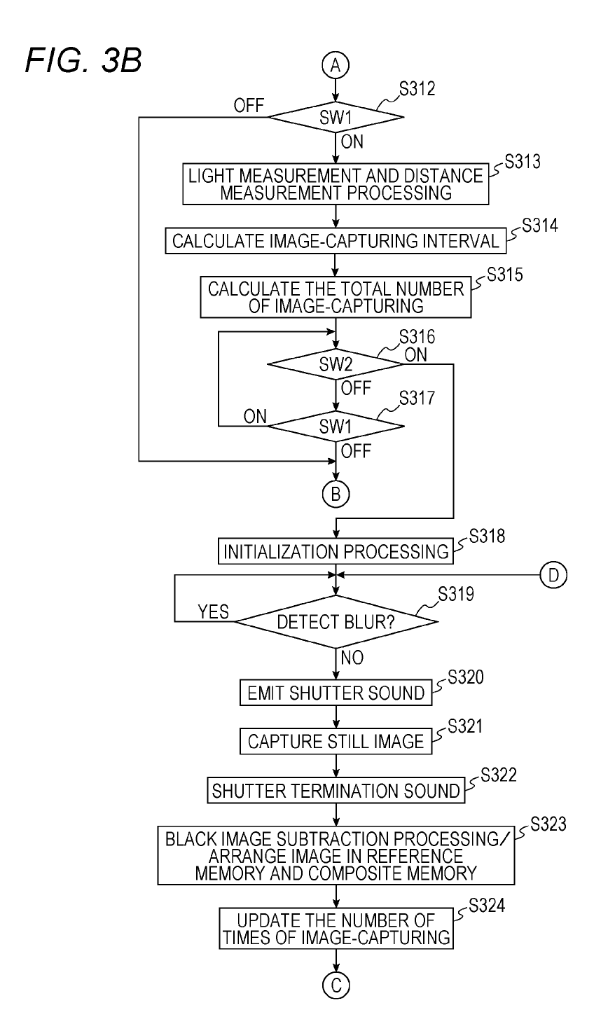

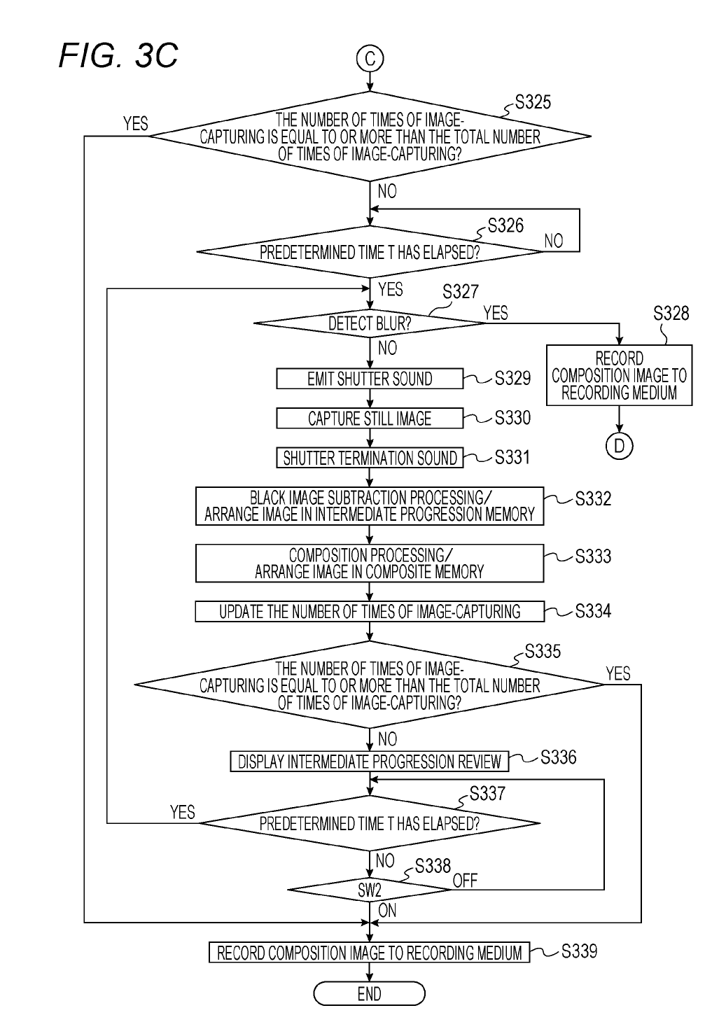

Starlit sky track image-capturing process according to the first exemplary embodiment will be explained with reference to FIGS. 3A to 3C, 4A to 4C, and 5A-1, 5A-2. FIGS. 3A to 3C illustrate a flowchart of processing of starlit sky track image-capturing according to the present exemplary embodiment.

The processing of FIGS. 3A to 3C is started when the digital camera 100 is activated, and a selection command is input with the operation unit 70 (press down of a DISP button 75 included in the operation unit 70) while the starlit sky track of the starlit sky mode, which is one of image-capturing modes, is set. The starlit sky mode includes four operation modes including starlit sky snap, starlit sky night view, starlit sky track, and starlit sky interval motion picture, and any one of them can be selected. In the starlit sky track, still picture image-capturing (image-capturing control) is performed multiple times with a single image-capturing command, and the still pictures are overlaid and composited, so that the tracks of stars are generated and recorded.

Since the starlit sky mode is a mode for performing wide angle image-capturing, the system control unit 50 may fix the image-capturing lens 103 at the wide angle end when the processing of the starlit sky mode is started. In a case where the user selects any one of the modes of the starlit sky mode or the starlit sky mode, the system control unit 50 may display the following guidance on the display unit 28.

A message indicating that the mode is a mode for capturing an image of a starlit sky

An advice prompting the user to perform image-capturing with the camera being fixed with a tripod (the starlit sky mode is image-capturing process performed in a dark place, and therefore, it takes a long exposure time, and hand-held image-capturing is likely to cause hand shake blur, and therefore, a message recommending tripod-fixed image-capturing is displayed. More specifically, the starlit sky mode is expected to be used with a tripod).

Processing of the starlit sky track will be explained with reference to FIGS. 3A to 3C.

In S301, the system control unit 50 displays an initial screen of starlit sky track image-capturing on the display unit 28.

In S302, the system control unit 50 determines whether the DISP button of the operation unit 70 is pressed down, and selection operation to another starlit sky mode has been performed or not. When the DISP button is determined to have been pressed down, S303 is subsequently performed, and when the DISP button is determined not to have been pressed down, S304 is subsequently performed.

In S303, the system control unit 50 receives user's operation for selecting any one of the starlit sky modes explained above, and performs processing of the selected mode. Hereinafter, the processing in a case where the starlit sky track is selected will be explained.

In S304, the system control unit 50 determines whether a menu screen is displayed by user operation, and switch operation of ON state/OFF state of a dark-place display is performed or not in the menu item of the dark-place display (a display mode for a dark place). When the switch operation is determined to be performed, S305 is subsequently performed, and when the switch operation is determined not to be performed, S306 is subsequently performed.

In S305, the switch processing of the dark-place display setting is performed. It should be noted that the dark-place display can be set with the menu item not only in the starlit sky mode but also program AE mode, aperture priority mode, shutter speed priority mode, manual mode, night view image-capturing mode, fireworks image-capturing mode which are expected to perform image-capturing in a dark place. In the dark-place display, the display of the hue on the display device such as an LCD is changed so that the user can easily see the display unit 28 even in a dark place. In the explanation about this case, for example, the ON state/OFF state of the dark-place display setting is switched in response to the user operation. Alternatively, automatic switching may be performed upon detection of an ambient environment. For example, when the brightness of the captured through image is determined to be low and in the dark place, the dark-place display setting may be automatically changed to the ON state, and when the brightness of the through image is determined to be bright and not in the dark place, the dark-place display setting may be automatically changed to the OFF state.

In S306, the system control unit 50 determines whether operation for white balance correction is performed with the operation unit 70. When the white balance correction operation is determined to be performed, S307 is subsequently performed, and when the white balance correction operation is determined not to be performed, S308 is subsequently performed.

In S307, setting of the white balance correction is done. In this case, the white balance correction value that is set with the operation unit 70 is held in the memory 32, and control is performed to apply a correction value to the image-capturing unit and the image processing unit 24. Thus, an image reflecting the white balance correction is displayed on the display unit 28.

In S308, the system control unit 50 determines whether operation for exposure correction is performed with the operation unit 70 or not. When the operation for exposure correction is determined to be performed, S309 is subsequently performed, and when the operation for exposure correction is determined not to be performed, S310 is subsequently performed.

In S309, the system control unit 50 holds the exposure correction value, which has been set with the operation unit 70, to the memory 32, and performs control so as to apply a correction value to the image-capturing unit and the image processing unit 24, thus performing the exposure correction.

In S310, the system control unit 50 determines whether the setting of a total image-capturing time is received with the controller wheel 73 of the operation unit 70. The total image-capturing time is a time (predetermined period of time T) for performing the starlit sky track image-capturing, and the user can set the total image-capturing time by making a selection from among options such as 10 minutes, 30 minutes, 60 minutes, and 120 minutes. The user may set a desired value. In other words, the total image-capturing time is a time expected as a time for capturing a series of tracks. When the total image-capturing time setting is determined to be performed, S311 is subsequently performed, and when the total image-capturing time setting is determined not to be performed, S312 is subsequently performed.

In S311, when the system control unit 50 stores the total image-capturing time, which is set in S318, to the memory 32, and also changes the total image-capturing time displayed on the display unit 28. It should be noted that the total image-capturing time held in the memory 32 may be recorded to the recording medium 200 in the power supply OFF state.

In S312, the system control unit 50 determines whether the first shutter switch signal SW1 is in the ON state due to half-press of the shutter button 61. When the first shutter switch signal SW1 is determined to be in the ON state, S313 is subsequently performed, when the first shutter switch signal SW1 is determined not to be in the ON state, S301 is performed again.

In S313, the system control unit 50 performs AF processing (distance measurement) to adjust the focal point of the image-capturing lens 103 to the subject, and performs AE processing (light measurement) to determine the aperture value and the shutter speed (exposure time) of the shutter 101.

In S314, the system control unit 50 calculates the image-capturing interval of the starlit sky track image-capturing by adding the processing time for a single image-capturing processing (black image subtraction processing, composition processing) to the shutter speed determined in S313.

In S315, the system control unit 50 derives the total number of times of image-capturing in the starlit sky track image-capturing by dividing the total image-capturing time, which is set in S311 of FIG. 3A, by the image-capturing interval calculated in S314.

In S316, the system control unit 50 determines whether the second shutter switch signal SW2 is in the ON state due to full-press of the shutter button 61. When the second shutter switch signal SW2 is determined to be in the ON state, S318 is subsequently performed, when the second shutter switch signal SW2 is determined not to be in the ON state, S317 is performed again.

In S317, the system control unit 50 determines whether the first shutter switch signal SW1 is in the ON state due to half-press of the shutter button 61. When the first shutter switch signal SW1 is determined to be in the ON state, S316 is performed again, when the first shutter switch signal SW1 is determined not to be in the ON state, S301 is performed again.

In S318, the system control unit 50 performs initialization processing such as noise reduction processing for many-seconds image-capturing and setting an initial value to the counter indicating the number of times of image-capturing of still picture image-capturing explained later.

In S319, the system control unit 50 determines whether the digital camera 100 is moving or not (whether there is a possibility of occurrence of blur when exposure is performed). When the digital camera 100 is determined to be moving (when blur is detected), the system control unit 50 waits until the digital camera 100 is determined not to be moving, and when the digital camera 100 is determined not to be moving, S320 is subsequently performed. Whether the digital camera 100 is moving or not is determined by causing the angular velocity sensor 42 to obtain the angular velocity of the digital camera 100 (i.e., information indicating whether there is a blur or not). At this occasion, when the angular velocity is equal to or more than a predetermined value (in accordance with a predetermined movement or more), the digital camera 100 is determined to be moving (movement is detected), and when the angular velocity is less than the predetermined value, the digital camera 100 is determined not to be moving. In the present disclosure, when the digital camera 100 is determined to be moving with an angular velocity less than a predetermined value, a captured still picture is determined to be a still picture that is less likely to be blurred.

In S320, the system control unit 50 causes the speaker 39 to emit a shutter start sound in accordance with the time when the shutter 101 opens. Accordingly, a person who captures an image can find the timing of the start of the image-capturing.

In S321, the system control unit 50 performs exposure under an image-capturing condition determined in S313, and captures an image of a subject such as a starlit sky and a night view.

In S322, the system control unit 50 causes the speaker 39 to emit a shutter termination sound according to termination of an exposure. Accordingly, a person who captures an image can find the completion of the exposure.

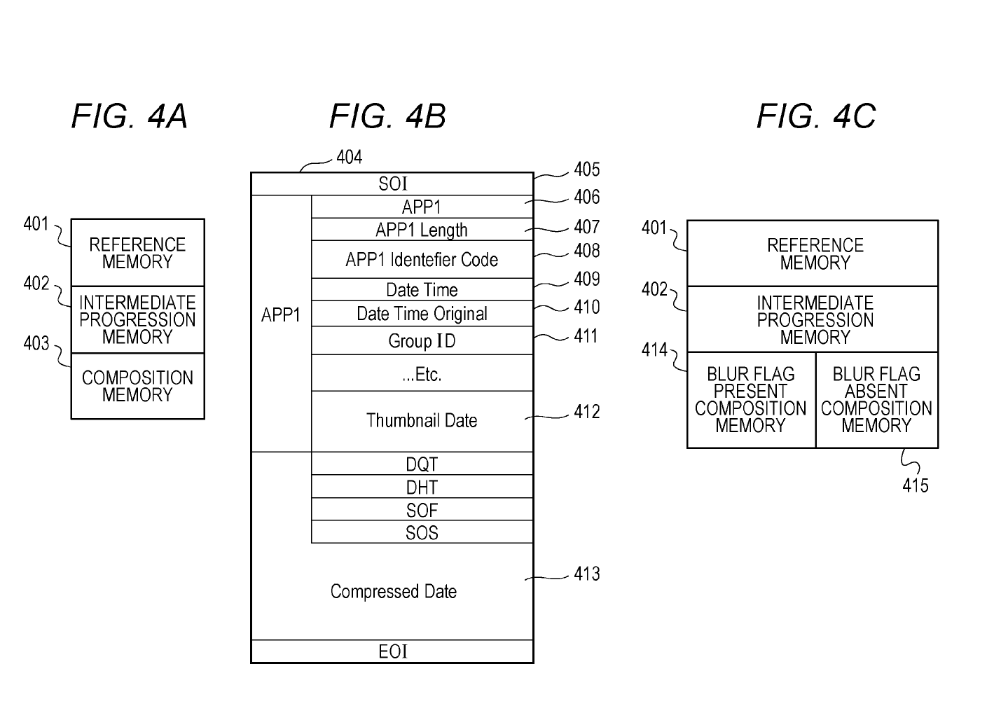

In S323, the system control unit 50 performs many-seconds image-capturing for capturing a black image by closing the shutter 101 in order to perform noise processing of many-seconds image-capturing performed in S321. Then, the image processing unit 24 processes the image obtained in S321 and the black image obtained in S323, thereby generating a still picture in which noise is reduced, and arranges (saves) the generated still picture to the reference memory 401 and the composition memory 403 as shown in FIG. 4A. FIG. 4A shows the inside of the memory 32, and a still picture serving as a reference of composition is saved in the reference memory 401. The still picture that is first captured after the first still picture or composition image is saved to the recording medium 200 is arranged in the reference memory 401 and the composition memory 403. Multiple still pictures captured to be composited are arranged, one by one, to an intermediate progression memory 402. It should be noted that all of the multiple still pictures captured to be composited may be saved to the intermediate progression memory 402, or only a single still picture captured last (the latest still picture) may be saved to the intermediate progression memory 402.

In S324, the system control unit 50 increases the image-capturing count saved in the system memory 52 by one (increases the number of times of image-capturing by one).

In S325, the system control unit 50 compares the current number of times of image-capturing and the total number of times of image-capturing derived in S315. Then, when the number of times of image-capturing is determined to be less than the total number of times of image-capturing, S326 is subsequently performed, and when the number of times of image-capturing is equal to or more than the total number of times of image-capturing, S339 is subsequently performed.

In S326, the system control unit 50 determines whether the image-capturing interval (predetermined period of time T) calculated in S314 has elapsed since the start of image-capturing in S320. When the image-capturing interval is determined to have elapsed, S327 is subsequently performed, and the image-capturing interval is determined not to have elapsed, the system control unit 50 waits until the image-capturing interval elapses. It should be noted that when SW2 is pressed down before the predetermined period of time T elapses, S339 is subsequently performed.

In S327, the system control unit 50 determines whether the digital camera 100 is moving or not (whether there is a possibility of occurrence of blur when exposure is performed) like S319. When the digital camera 100 is determined to be moving, S328 is subsequently performed, and when the digital camera 100 is determined not to be moving, S329 is subsequently performed.

In S328, the system control unit 50 records the composition image composited in S333 and arranged in the composition memory 403 to the recording medium 200 (nonvolatile memory) as an image file, and proceeds to S319. In this case, the images arranged in the reference memory 401, the intermediate progression memory 402, and the composition memory 403 are erased after the composition image is recorded. When only a the digital camera 100 is determined to be moving when only a single image is captured (when a single still picture is arranged in the composition memory 403), the image arranged in the composition memory 403 in S323 is recorded, and S319 is subsequently performed again.

The processing in S329 to S331 is the same as the processing in S320 to S322.

In S332, the system control unit 50 closes the shutter 101 and captures a black image for many seconds in order to perform noise processing of many-seconds image-capturing performed in S330. Then, the image processing unit 24 processes the image obtained in S330 and the black image obtained in S332 to generate a still image in which noise is reduced, and arranges the generated still picture in the intermediate progression memory 402. It should be noted that the still picture processed last in S332 is referred to as the latest still picture.

In S333, the system control unit 50 compares the still picture saved in the reference memory 401 and the latest still picture arranged in the intermediate progression memory 402 in S332, and extracts only the portions of pixels where the brightness is brighter in the latest still picture. The portions determined to be brighter than the image of the reference memory 401 are added to the image stored in the composition memory 403, so that a composition image is generated (relatively brighter composition). In this manner, only the brighter subject such as stars are overlaid and composited every time image capture is performed, so that a star track image is generated.

In S334, the system control unit 50 increases the image-capturing count by one (increases the number of times of image-capturing by one).

In S335, the system control unit 50 compares the current number of times of image-capturing and the total number of times of image-capturing derived in S315. Then, when the number of times of image-capturing is determined to be less than the total number of times of image-capturing, S336 is subsequently performed, and when the number of times of image-capturing is determined to be equal to or more than the total number of times of image-capturing, S339 is subsequently performed.

In S336, the system control unit 50 displays the composition image generated in S333 (the image in the composition memory 403) on the display unit 28.

In S337, the system control unit 50 determines whether the image-capturing interval calculated in S314 (predetermined period of time T) has elapsed since the start of image-capturing in S330. When the image-capturing interval is determined to have elapsed, S327 is subsequently performed, and when the image-capturing interval is determined not to have elapsed, S338 is subsequently performed.

In S338, the system control unit 50 determines whether the second shutter switch signal SW2 is in the ON state due to full-press of the shutter button 61. When the second shutter switch signal SW2 is determined to be in the ON state, S339 is subsequently performed, when the second shutter switch signal SW2 is determined not to be in the ON state, S337 is performed again.

In S339, the system control unit 50 records the composition image composited in S333 and arranged in the composition memory 403 to the recording medium 200 (nonvolatile memory) as an image file, and terminates the processing of the starlit sky track image-capturing.

According to the processing explained above, in the series of image-capturing for letting the user capture images of a subject such as a starlit sky multiple times and compositing the image, the images are composited without including a captured image that is likely to be blurred, and therefore, a composition image which is less likely to be blurred can be obtained.

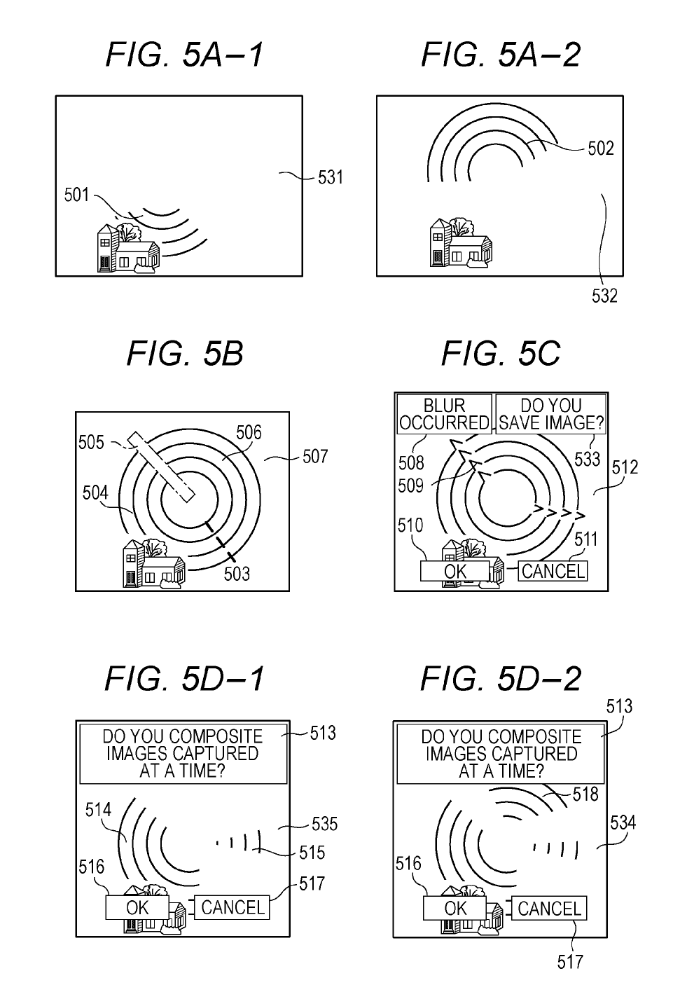

FIGS. 5A-1 to 5A-2 show an example of composition images obtained in the processing according to the exemplary embodiment. A track 501 of FIG. 5A-1 and a track 502 of FIG. 5A-2 illustrate tracks of stars appearing in composition images S31, S32, respectively, obtained by compositing multiple images captured in the series of starlit sky track taken from the same position. The digital camera 100 is determined to be moving (blur is detected) while the images of the track 501 and the track 502 are captured, and therefore, the composition images are saved separately. Therefore, it is understood from FIGS. 5A-1 and A-2 that the system control unit 50 detects blur after the image of the track 501 is captured, and stores the composition image 531 in which the captured image of the track 501 appears to the recording medium 200. Further, it is understood that the image-capturing is performed again after the blur has ceased, and the composition image S32 in which the track 502 appears is obtained. As described above, the digital camera 100 is determined not to be moving continuously in S327, and the tracks of the portions of the images captured and composited are recorded. Therefore, according to the present exemplary embodiment, a still picture that is likely to be blurred is not included in the tracks, and the images of the tracks can be captured in the total image-capturing time that has been set.

In the present exemplary embodiment, when blur is detected, image-capturing is not performed until blur is no longer detected (while the blur is detected). Alternatively, even when the blur is detected, image-capturing may be performed. In this case, images captured from when a blur is detected to when blur is no longer detected are respectively saved to the recording medium 200, and are not included in the composition image.

In S328, S339, when the composition image arranged in the composition memory 403 is saved to the recording medium 200, the image file 404 is saved in the data structure as shown in FIG. 4B. The image file 404 includes a marker (SOI) 405 indicating the start of the image file at the head of the image file, and has an application marker (APP1) 406 corresponding to the header portion arranged after the marker. The application marker (APP1) 406 includes:

size (APP1 Length) 407,

Identification code of application marker (APP1 Identifier Code) 408,

Creation date and time of image data (Date Time) 409,

Date and time when image data are generated (Date Time Original) 410,

Group ID 411,

Thumbnail image (Thumbnail Data) 412,

Main body image (Compressed data) 413.

The Group ID 411 records a Group ID and an In-Group number (symbol) every time each image is saved in a case where a Group ID is set. The main body image 413 records composition images (the composition image 531, the composition image S32, and the like).

In S319, in the time of waiting until the digital camera 100 no longer moves, the interval between image-capturing and image-capturing passes the image-capturing interval that has been set, and image-capturing of N images may not be completed within the total image-capturing time that has been set in S310. In this case, image-capturing may be continued until the total number of images are captured, or the image-capturing of the starlit sky track may be terminated even if the total number of images have not yet been captured when the image-capturing time elapses.

In the above explanation, for example, relatively brighter composition is performed as the composition. Alternatively, relatively darker composition can be performed when it is desired to obtain a track of a dark subject.

### Modification of First Exemplary Embodiment

In the explanation about the first exemplary embodiment, the case where the digital camera 100 moved (the case where a blur may occur) in the processing of the starlit sky track image-capturing has been explained with reference to the flow of image-capturing. However, the above flow can be applied in the same manner to the case where a change in the subject brightness or the color of the subject that is not acceptable to the user is detected. In this case, the change in the subject brightness or the color of the subject that is not acceptable to the user does not include a movement and a change of brightness of a desired subject in a case where an image of a track such as movement of a star over the elapse of a time is captured in the starlit sky track. When the subject brightness and the color of the subject change by a value equal to or more than a predetermined value, there is considered to be a subject or a light source entering into the image-capturing range against the intention of the user, and there is a possibility that a change that is not acceptable to the user appears in the composition image.

Even when the subject brightness or the color of the subject is detected, the example of the configuration of the digital camera in FIGS. 1 and 2, the flow diagrams in FIGS. 3A to 3C, the drawing of the image file in FIGS. 4A to 4C, and the figure of the captured image in FIGS. 5A-1 to 5D-2 are almost the same as those in the first exemplary embodiment for detecting blur. Different points will be hereinafter explained.

In S313 of the present modification, when the system control unit 50 detects a change in the image-capturing range due to a change in the subject brightness, the system control unit 50 measures the brightness (exposure value) in the image-capturing range, and stores the measured value to the memory 32. When a light of a truck or a light of a flashlight comes into the image-capturing range in the image-capturing of the starlit sky, these lights are included in the composition image, and the composition image including lights other than the track image desired by the user may be generated. Whether a light and the like that is not the subject of which track is being image-captured comes into the image-capturing range can be detected based on the change of the value of the brightness. Further, when a change in the image-capturing range due to a change of the color of the subject is detected, the color temperature in the image-capturing range is measured, and the measured value is stored to the memory 32.

In S319 of the present modification, instead of the determination as to whether a blur is detected or not in the first exemplary embodiment, or together with the determination as to whether a blur is detected or not in the first exemplary embodiment, the following processing is performed. The system control unit 50 measures the brightness or the color temperature, and determines whether the brightness has changed by one or more (a predetermined value or more) and the color temperature has changed by 1000 K or more (a predetermined value or more) than the brightness or the color temperature stored in the memory 32 through measurement in S313. The subject brightness or the color of the subject is determined to have changed on the basis of a detection result indicating that the brightness has changed by one or more (a predetermined value or more) or the color temperature has changed by 1000 K or more (a predetermined value or more). More specifically, when the subject brightness or the color of the subject has changed by a predetermined value or more, the subject brightness or the color of the subject is detected to have changed accordingly. When it is determined that there is a change, the system control unit 50 waits until it is determined that there is no longer any change (the value stored in the memory 32 and the value measured are compared, and the subject brightness or the color of the subject changes by a value less than the predetermined value), and in the other case, S320 is subsequently performed. In a case where it is determined that there is no longer any change, the value of the brightness or the color temperature measured in S313 is erased from the memory 32, and the value of the brightness or the color temperature measured in S319 is stored to the memory 32. In order to detect a change in the image-capturing range, the brightness may not be necessarily one or more, and the color temperature may not be necessarily 1000 K or more, and they may be set in accordance with the subject of which track is image-captured, an image-capturing environment, and the like. They may not be stored to the memory 32 again every time the brightness or the color temperature is measured, and the value stored first in S313 may be applied as the value for comparison.

In S327 of the present modification, instead of the determination as to whether a blur is detected or not in the first exemplary embodiment, or together with the determination as to whether a blur is detected or not in the first exemplary embodiment, the following processing is performed. The system control unit 50 measures the brightness or the color temperature, and compares the measured value and the value of the brightness or the color temperature measured in S313 or S319 immediately before and stored to the memory 32, and determines whether the brightness has changed by one or more or the color temperature has changed by 1000 K or more. When the brightness is determined to have changed by one or more (a predetermined value or more) or the color temperature is determined to have changed by 1000 K or more (a predetermined value or more), the subject brightness or the color of the subject is determined to have changed. When the subject brightness or the color of the subject is determined to have changed, the system control unit 50 waits until it is determined that there is no longer any change (the value stored in the memory 32 and the value measured are compared, and the subject brightness or the color of the subject changes by a value less than the predetermined value), and in the other case, S320 is subsequently performed. In a case where it is determined that there is no longer any change, the value of the brightness or the color temperature measured in S319 or S327 immediately before is erased from the memory 32, and the latest value of the brightness or the color temperature measured in S327 is stored to the memory 32. As described above, a light and the like that comes into the image-capturing range can be detected through comparison with the brightness or the color temperature obtained when the image-capturing is performed immediately before.

When a change in the subject brightness or the color of the subject is detected, in S319 or S327, the brightness or the color temperature stored in the memory 32 is not rewritten.

According to the example explained above, composition is performed without including a captured image that may have a change in the subject brightness or the color of the subject, and therefore, a composition image which is less likely to involve a change in the subject brightness or the color of the subject can be obtained.

### Second Exemplary Embodiment

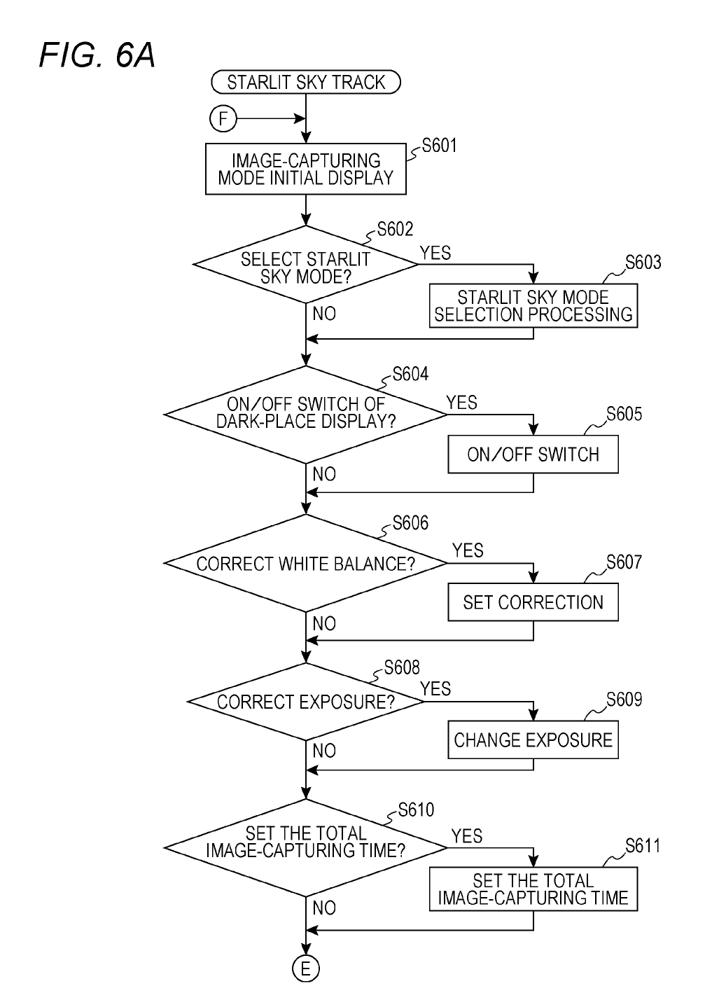

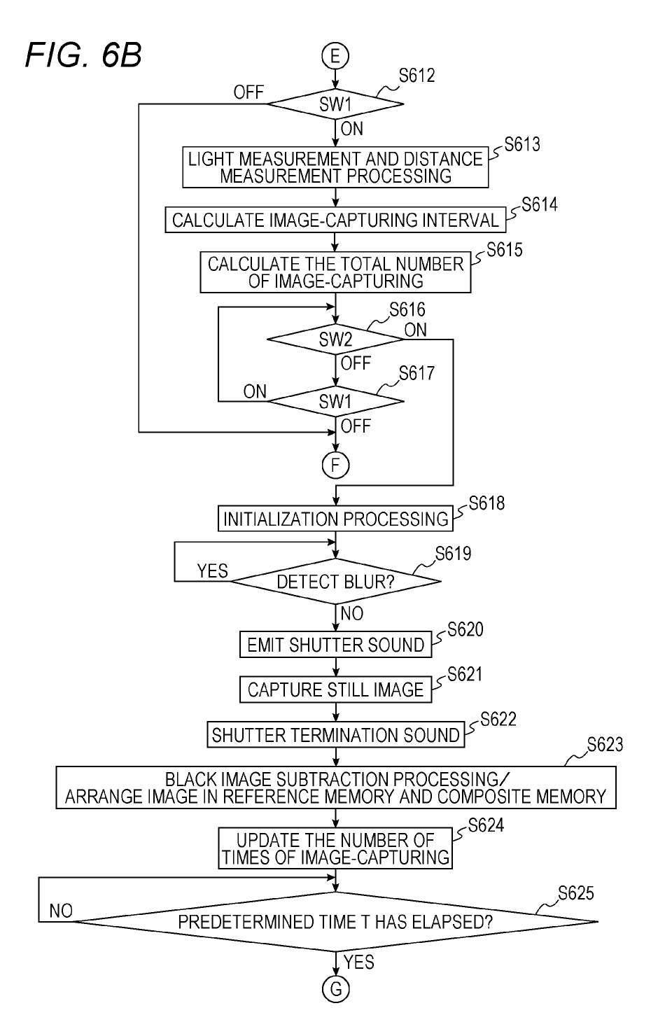

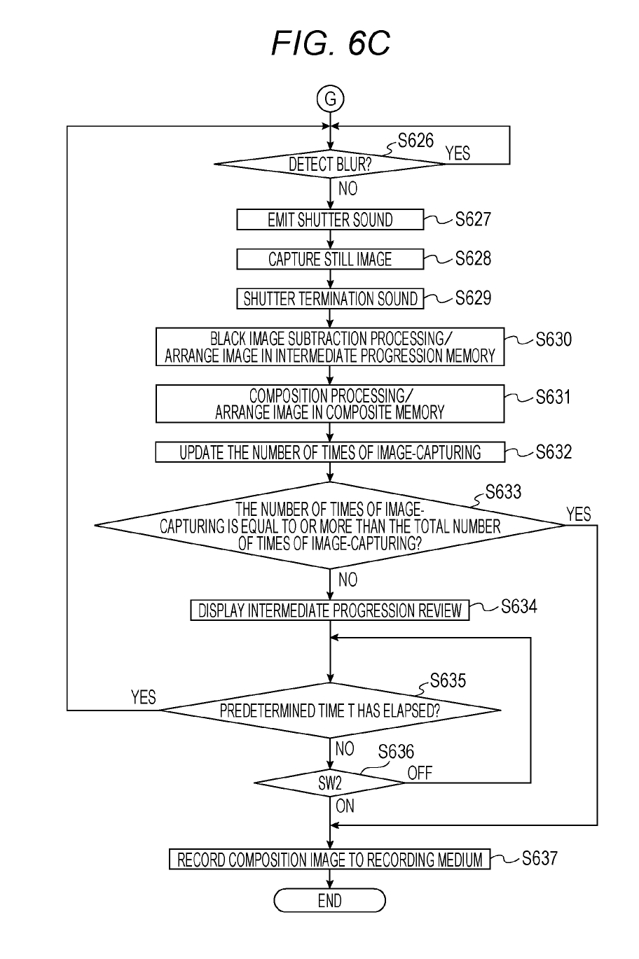

Subsequently, starlit sky track image-capturing according to the second exemplary embodiment will be explained with reference to FIGS. 5B and 6A to 6C. FIGS. 6A to 6C illustrate a flowchart of processing of the starlit sky track image-capturing according to the present exemplary embodiment. The second exemplary embodiment is the same as the first exemplary embodiment except the flowchart of FIGS. 3A to 3C explained above. In the first exemplary embodiment, when it is detected that the digital camera 100 is moving, the composition image composited until then is saved as the image file to the recording medium 200. In the second exemplary embodiment, the system control unit 50 waits until the movement is no longer detected, and the system control unit 50 generates a composition image in which the track before occurrence of the blur and the track after the termination of the blur appear in the same image.

S601 to S624 are the same processing as that in S301 to S324 of FIGS. 3A and 3B.

S625 is the same processing as that in S326 of FIG. 3C.

In S626, the system control unit 50 determines whether the digital camera 100 is moving or not (whether there is a possibility of occurrence of blur when exposure is performed) like S619. When the digital camera 100 is determined to be moving, the system control unit 50 waits until the digital camera 100 is determined not to be moving, and when the digital camera 100 is determined not to be moving, S627 is subsequently performed.

The processing in S627 to S637 is the same as the processing in S329 to S339 of FIG. 3C.

According to the processing explained above, in the series of image-capturing for letting the user capture images of a subject such as a starlit sky multiple times and compositing the image, the images are composited without including a captured image that is likely to be blurred, and therefore, a composition image which is less likely to be blurred can be obtained.

FIG. 5B shows an example of a composition image obtained in the processing according to the second exemplary embodiment. In the second exemplary embodiment, a composition image 507 as shown in FIG. 5B can be captured. A broken line 503 of FIG. 5B indicates a portion where the track image-capturing is started, and a track 504 indicates a track that is image-captured after the start of the track image-capturing. The track is not appearing in the area indicated by the area 505 of FIG. 5B, and it is understood that, in a period of time when a star is flowing in the area indicated in the area 505, a blur is detected, and therefore, image-capturing is not performed. Therefore, in the present exemplary embodiment, image-capturing is not performed for a still picture that is likely to be blurred in the image, and therefore, the image of the track can be captured without including the still picture that is likely to be blurred in the track. Further, when a blur is no longer detected, the image-capturing is started again, and the image is composited with the composition image in which the track of the track 504 appears. The track 506 is a track after a blur is no longer detected. It should be noted that the broken line 503 and the line indicating the area 505 are shown for the sake of convenience, and are not appearing in the composition image 507.

More specifically, in the track image-capturing for capturing and compositing still pictures for the total number of times of image-capturing, image-capturing is not performed when the digital camera 100 is determined to be moving, and therefore, composition is performed while a still picture that is likely to be blurred is excluded. Therefore, according to the present exemplary embodiment, image capturing of a track that does not include a still picture that is likely to be blurred can be performed easily.

### Modification of Second Exemplary Embodiment

In the explanation about the second exemplary embodiment, the case where the digital camera 100 moved (the case where a blur may occur) in the processing of the starlit sky track image-capturing has been explained with reference to the flow of image-capturing. However, the above flow can be applied in the same manner to the case where a change in the subject brightness or the color of the subject that is not acceptable to the user is detected. Even when the subject brightness or the color of the subject is detected, the example of the configuration of the digital camera in FIGS. 1 and 2, the flow diagrams in FIGS. 6A to 6C, the drawing of the image file in FIGS. 4A to 4C, and the figure of the captured image in FIGS. 5A-1 to 5D-2 are almost the same as those in the second exemplary embodiment for detecting blur. Different points will be hereinafter explained.

S619 of the present modification is the same processing as S319 of the modification of the first exemplary embodiment.

In S626 of the present modification, instead of the determination as to whether a blur is detected or not in the second exemplary embodiment, or together with the determination as to whether a blur is detected or not, the following processing is performed. Like the processing explained in S319 of the modification of the first exemplary embodiment, the system control unit 50 measures the brightness or the color temperature, and determines whether the brightness has changed by one or more and the color temperature has changed by 1000 K or more than the brightness or the color temperature measured and recorded in S619. The subject brightness or the color of the subject is determined to have changed in a case where the brightness has changed by one or more (a predetermined value or more) or the color temperature has changed by 1000 K or more (a predetermined value or more). When it is determined that there is a change, the system control unit 50 waits until it is determined that there is no longer any change (the value stored in the memory and the value measured are compared, and the subject brightness or the color of the subject changes by a value less than the predetermined value), and in the other case, S627 is subsequently performed. In a case where it is determined that there is no longer any change, the value of the brightness or the color temperature measured in S619 is erased from the memory 32, and the value of the brightness or the color temperature measured in S626 is stored to the memory 32.

According to the example explained above, composition is performed without including a captured image that may have a change in the subject brightness or the color of the subject, and therefore, a composition image which is less likely to involve a change in the subject brightness or the color of the subject can be obtained.

### Third Exemplary Embodiment

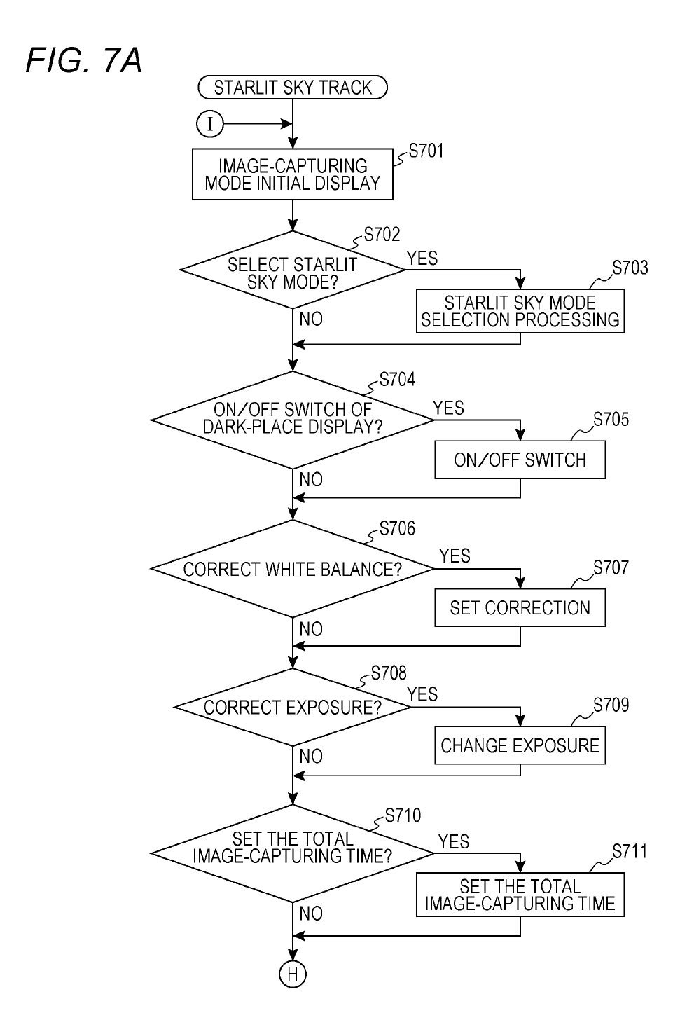

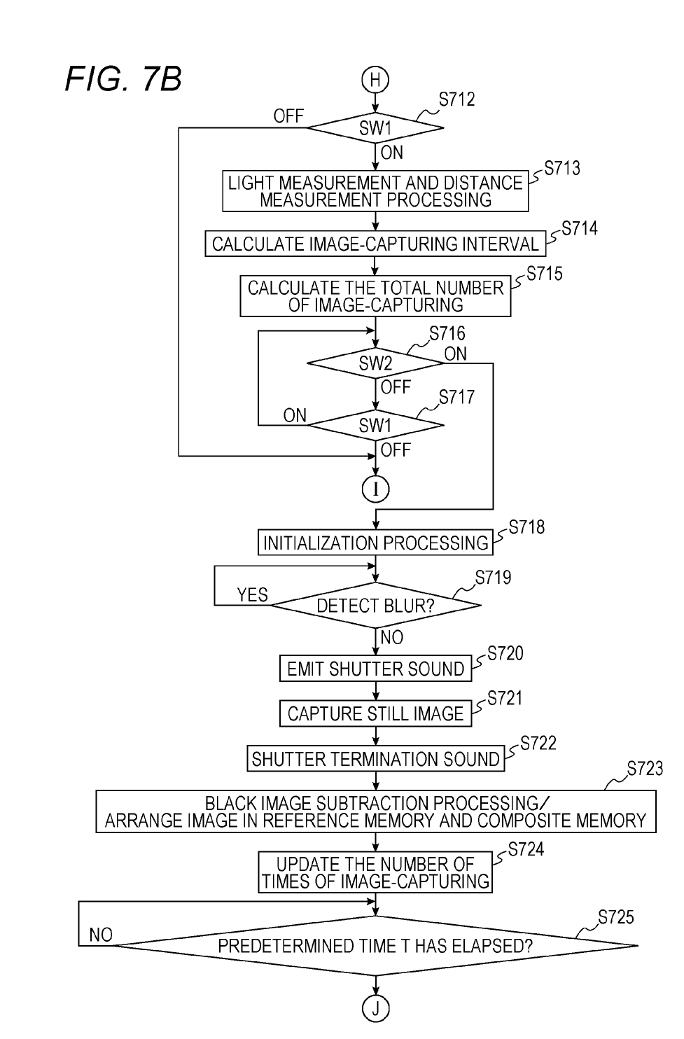

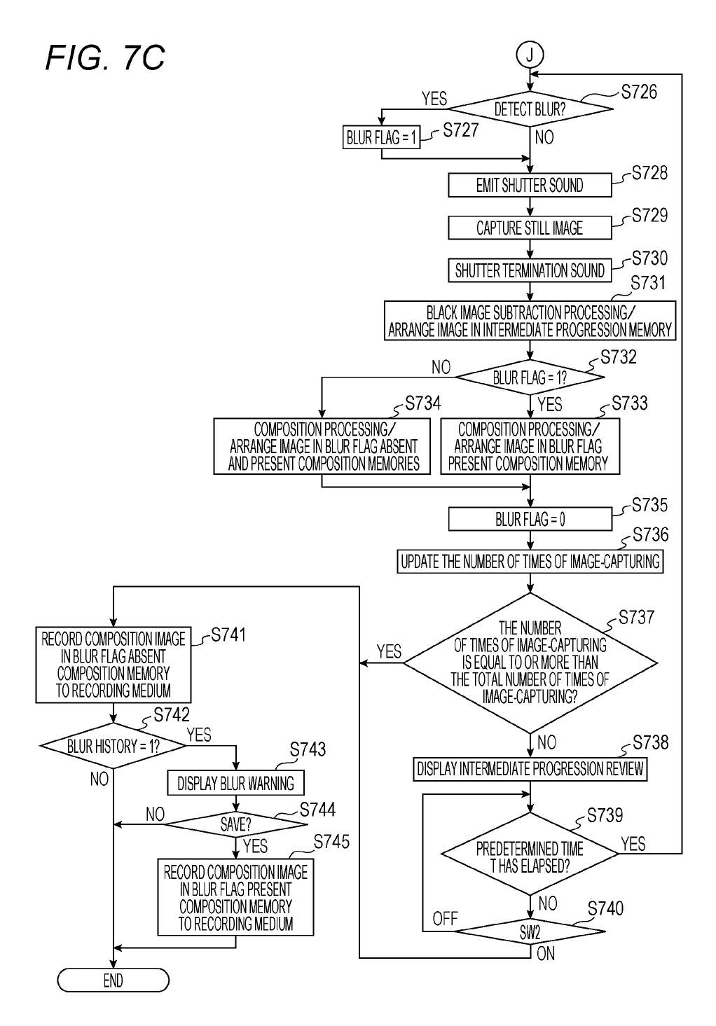

Subsequently, starlit sky track image-capturing according to the third exemplary embodiment will be explained with reference to FIGS. 5C and 7A to 7C. FIGS. 7A to 7C illustrate a flowchart of processing of the starlit sky track image-capturing according to the present exemplary embodiment. The third exemplary embodiment is the same as the first and second exemplary embodiments except the flowchart of FIGS. 3A to 3C explained above. In the first exemplary embodiment, when it is detected that the digital camera 100 is moving, the composition image composited until then is saved as the image file to the recording medium 200, and in the second exemplary embodiment, the system control unit 50 waits until the movement of the digital camera 100 is no longer detected. In the third exemplary embodiment, a blur flag is set for a recorded still picture in a case where the digital camera 100 is detected as moving, and then the image-capturing is performed, and a composition image as well as a warning indicating that a still picture is included that may cause a blur are displayed when a series of image-capturing is terminated.

S701 to S724 are the same processing as that in S301 to 324 of FIGS. 3A and 3B.

S725 is the same processing as that in S326 of FIG. 3C.

In S726, the system control unit 50 determines whether the digital camera 100 is moving or not (whether there is a possibility of occurrence of blur when exposure is performed). When the digital camera 100 is determined to be moving, S727 is subsequently performed, and when the digital camera 100 is determined not to be moving, S728 is subsequently performed.

In S727, the system control unit 50 sets a blur flag (blur flag=1 is stored to the system memory 52). The blur flag is to indicate the possibility that a blur may occur in a still picture that is captured immediately after this. When the blur flag becomes one when the blur flag was zero, then blur history=1 is stored to the system memory 52. When the blur is not detected in S726 only once, blur history=0 is stored to the system memory 52. The blur flag is changed to zero or one every time the system control unit 50 determines whether there is a blur or not in S726, but once the blur history changes from zero to one, the blur flag is not changed in the series of image-capturing. In the processing before S726, blur flag=0 is stored to the system memory 52, and every time image-capturing is performed, a determination is made as to whether a blur occurs or not, so that whether a blur may have occurred in the captured image (the latest still picture) or not can be found.

S728 to S731 are the same processing as S329 to S332 of FIG. 3C.

In S732, the system control unit 50 determines whether blur flag=1 holds or not in S727 immediately before. When blur flag=1 is determined to hold, S733 is subsequently performed, and when blur flag=1 is determined not to hold, S734 is subsequently performed.

In S733, the system control unit 50 compares the latest still picture and the image in the reference memory 401 to extract a bright portion, and performs composition processing for adding the portion to the composition image having blur flag=1 which is in a blur flag present composition memory 414 of FIG. 4C, and arranges the composition image to the blur flag present composition memory 414. However, when a composition image is not arranged in the blur flag present composition memory 414, composition processing is performed on the composition image in the blur flag absent composition memory 415 of FIG. 4C. Both of the blur flag absent composition memory 415 and the blur flag present composition memory 414 are a part of the composition memory, and configured to save a composition image including an image for which a blur flag is set and a composition image including only an image for which a blur flag is not set in such a manner that they are distinguished from each other. The composition image obtained by compositing only still pictures captured immediately after storage to the system memory 52 and blur flag=0 are arranged in the blur flag absent composition memory 415. In the blur flag present composition memory 414, the composition image including still pictures captured immediately after storage to the system memory 52 and blur flag=1 are arranged, and addition processing of an image is performed every time image-capturing is performed regardless of the value of the blur flag.

In the present exemplary embodiment, a composition image including all the still pictures of which blur flag=1 is arranged in the blur flag present composition memory 414. However, when multiple still pictures of which blur flag=1 are captured, a user may configure, in advance, which of the still pictures from the first one is to be composited, or how many still pictures are to be included in the composition.

In S734, the system control unit 50 compares the latest still picture and the image in the reference memory 401 to extract a bright portion, and performs composition processing for adding the portion to the composition image of the blur flag absent composition memory 415, and arranges the composition image to the blur flag absent composition memory 415. Further, composition processing is performed to add a portion brighter as compared with the image in the reference memory 401 to the composition image having blue flag=1 in the blur flag present composition memory 414, and the composition image is arranged in the blur flag present composition memory 414.

In S735, the system control unit 50 stores blur flag=0 to the system memory 52. As described above, the blur flag is set to zero before subsequent image-capturing is started.

S736 is the same processing in S334 of FIG. 3C.

In S737, the system control unit 50 compares the current number of times of image-capturing and the total number of times of image-capturing derived in S715. Then, when the number of times of image-capturing is less than the total number of times of image-capturing, S738 is subsequently performed, and the number of times of image-capturing is equal to or more than the total number of times of image-capturing, S741 is subsequently performed.

S738 to S739 is the same processing as S336 to S337 of FIG. 3C.

In S740, the system control unit 50 determines whether the second shutter switch signal SW2 is in the ON state due to full-press of the shutter button 61. When the second shutter switch signal SW2 is determined to be in the ON state, S741 is subsequently performed, and the second shutter switch signal SW2 is determined not to be in the ON state, S739 is performed again.

In S741, the system control unit 50 records the composition image in the blur flag absent composition memory 415 to the recording medium 200.

In S742, the system control unit 50 determines whether blur history=1 holds or not. When blur history=1 is determined to hold, S743 is subsequently performed, and blur history=1 is determined not to hold, the processing of the starlit sky track is terminated.

In S743, the system control unit 50 displays, on the display unit 28, the composition image arranged in the blur flag present composition memory 414 and a warning 508 for notifying the user that a blur occurred in the composition image being displayed as shown in FIG. 5C. By giving such warning 508, a user can find that the blur is included as shown in the blur 509 without checking the details of the track, and can recognize the composition image including the still picture in which a blur may have occurred.

In S744, the system control unit 50 receives a selection operation as to whether the composition image 512 displayed in S743 as shown in FIG. 5C is recorded from the blur flag present composition memory 414 to the recording medium 200. At this occasion, a question 533 asking the user as to whether an image being displayed is saved (recorded) or not as shown in FIG. 5C is displayed on the display unit 28. When the user makes a selection to record the composition image being displayed, S744 is subsequently performed, and when the user makes a selection not to record the composition image being displayed, the processing of the starlit sky track is terminated. In this case, selection items are displayed so that an OK display 510 as shown in FIG. 5C, or a cancel display 511 can be selected. The user can use the arrow key 74 to put the focus on any one of the selection items, and determine (select) the focused selection item with a SET button.

In S745, the system control unit 50 records the composition image selected to be saved in S744 to the recording medium 200 (nonvolatile memory) as the image file 404.

According to the processing explained above, in the series of image-capturing for letting the user capture images of a subject such as a starlit sky multiple times and compositing the image, the images are composited without including a captured image that is likely to be blurred, and therefore, a composition image which is less likely to be blurred can be obtained. Even when a still picture that is likely to be blurred is included but no blur actually occurs, the composition image thereof can be obtained. Alternatively, even in a case of a blur acceptable to the user, the composition image can be obtained. Therefore, according to the present exemplary embodiment, when a blur is detected, the series of image-capturing can be performed without including them in the image-capturing range. More specifically, the user can confirm and save both of the images of the composition image (track) including a still picture that is determined to be blurred and a composition image not including the still picture.

### Modification of Third Exemplary Embodiment

In the explanation about the third exemplary embodiment, the case where the digital camera 100 moved (the case where a blur may occur) in the processing of the starlit sky track image-capturing has been explained with reference to the flow of image-capturing. However, the above flow can be applied in the same manner to the case where a change in the subject brightness or the color of the subject that is not acceptable to the user is detected. Even when the subject brightness or the color of the subject is detected, the example of the configuration of the digital camera in FIGS. 1 and 2, the flow diagrams in FIGS. 7A to 7C, the drawing of the image file in FIGS. 4A to 4C, and the figure of the captured image in FIGS. 5A-1 to 5D-2 are almost the same as those in the third exemplary embodiment for detecting blur. Different points will be hereinafter explained.

S719 of the present modification is the same processing as S319 of the modification of the first exemplary embodiment.

In S726 of the present modification, instead of the determination as to whether a blur is detected or not in the third exemplary embodiment, or together with the determination as to whether a blur is detected or not, the following processing is performed. The system control unit measures the brightness or the color temperature, and determines whether the brightness has changed by one or more and the color temperature has changed by 1000 K or more than the brightness or the color temperature measured and recorded in S719. The subject brightness or the color of the subject is determined to have changed in a case where the brightness has changed by one or more (a predetermined value or more) or the color temperature has changed by 1000 K or more (a predetermined value or more). When it is determined that there is a change, S727 is subsequently performed. In a case where it is determined that there is no longer any change, the value of the brightness or the color temperature measured in S719 is erased from the memory 32, and the value of the brightness or the color temperature measured in S726 is stored to the memory 32, and S728 is subsequently performed.

In S727 of the present modification, the system control unit 50 sets a brightness change flag in a case where the brightness is measured, and the system control unit 50 sets a color temperature change flag in a case where the color temperature is measured. In the third exemplary embodiment, a blur flag has been explained, but in a case where the brightness is measured, a brightness change flag shows a flag indicating whether there is a change in the image-capturing range of the series of image-capturing, and in a case where the color temperature is measured, a color temperature change flag shows a flag indicating whether there is a change in the image-capturing range of the series of image-capturing. Even in a case where a determination is made as to whether there is a change in the image-capturing range on the basis of the brightness or the color temperature, the flow of the image-capturing using the flag is the same as the case of the blur flag. More specifically, the subsequent processing can be applied by reading the blur flag as the brightness change flag or the color temperature change flag.

In S743 of the present modification, in a case where a change in the image-capturing range is detected on the basis of the subject brightness or the color of the subject, the system control unit 50 gives a warning indicating that there is a change in the image-capturing range.

According to the example explained above, composition is performed without including a captured image that may have a change in the subject brightness or the color of the subject, and therefore, a composition image which is less likely to involve a change in the subject brightness or the color of the subject can be obtained. Even when a still picture that is likely to involve a change in the subject brightness or the color of the subject is included but actually there is no change in the subject brightness or the color of the subject, the composition image thereof can be obtained. Even when there is a change in the subject brightness to such a degree that is acceptable to the user or there is a change in the color of the subject to such a degree that is acceptable to the user, the composition image thereof can be obtained. Therefore, according to the present exemplary embodiment, when a change in the subject brightness or a change in the color of the subject is detected, the series of image-capturing can be performed without including them in the image-capturing range. More specifically, the user can confirm and save both of the images of the composition image (track) including a still picture that is determined to involve a change in the subject brightness or a change in the color of the subject and a composition image not including the still picture.

### Fourth Exemplary Embodiment

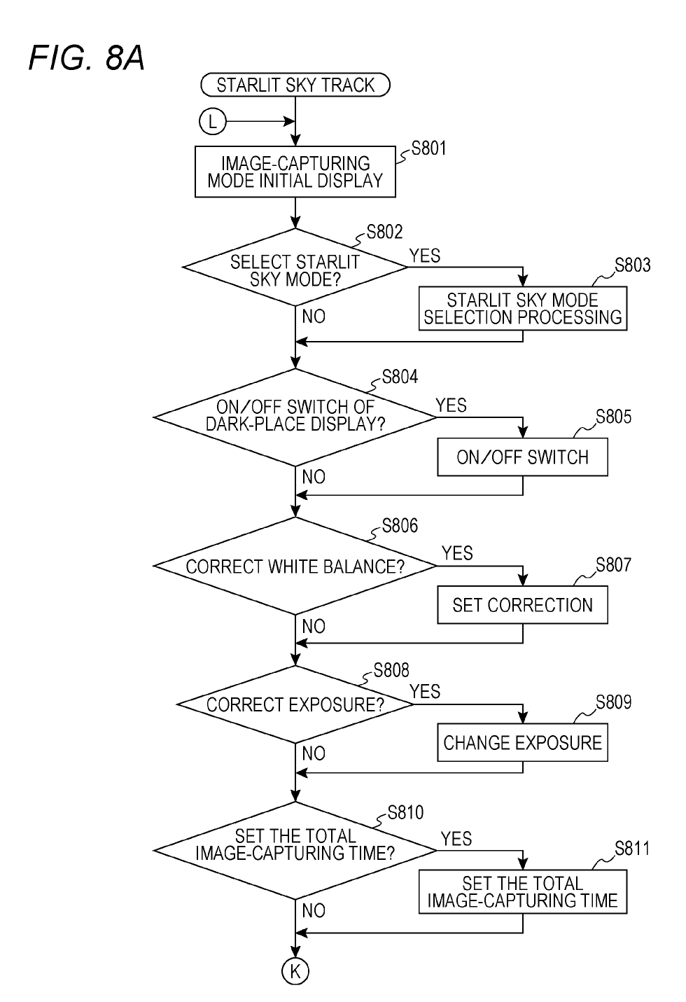

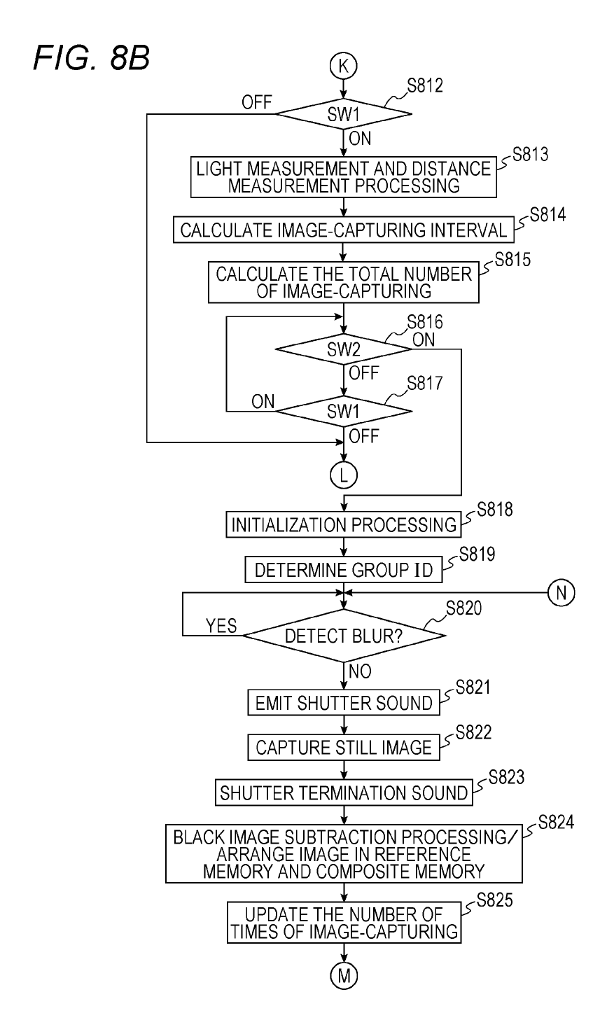

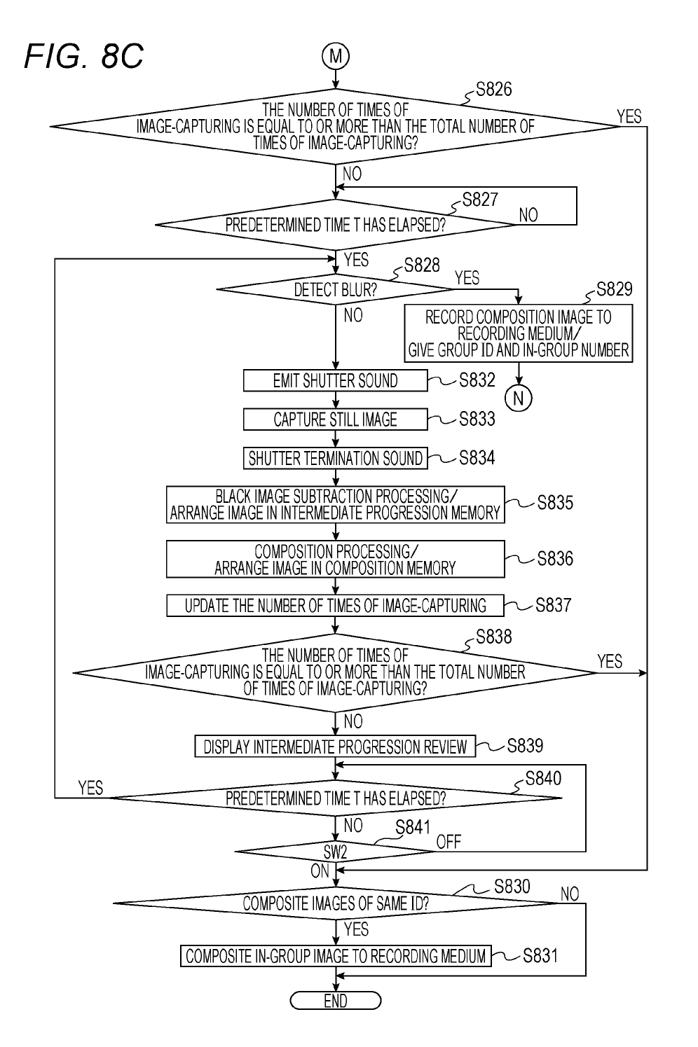

Subsequently, starlit sky track image-capturing according to the fourth exemplary embodiment will be explained with reference to FIGS. 5D-1, 5D-2, and FIGS. 8A to 8C. FIGS. 8A to 8C illustrate a flowchart of processing of the starlit sky track image-capturing according to the present exemplary embodiment. The fourth exemplary embodiment is the same as the first, second, and third exemplary embodiments except the flowchart of FIGS. 3A to 3C explained above. In the first exemplary embodiment, when it is detected that the digital camera 100 is moving, the composition image composited until then is saved to the recording medium 200, and in the second exemplary embodiment, the system control unit 50 waits until the system control unit 50 no longer detects that the digital camera 100 is moving. In the third exemplary embodiment, when it is detected that the digital camera 100 is moving, a blur flag is set, and then image-capturing is performed, and a composition image including the blur flag and a composition image not including a blur flag are separately arranged in the composition memory 403. In the fourth exemplary embodiment, when it is detected that the digital camera 100 is moving, image-capturing is not performed, and the composition image captured until then is saved to the recording medium 200 as an image file, and composition images recorded after the termination of image-capturing can be composited in series-composition. In this case, the series-composition means that composition images made by compositing multiple still pictures are further composited.

S801 to S818 are the same processing as S301 to S318 of FIGS. 3A and 3B.

In S819, the system control unit 50 determines a Group ID (identifier). This Group ID is a unique ID that is set in each of the series of image-capturing in accordance with a single image-capturing command (SW2), and is generated from a random number, a current time, and the like. Alternatively, the user may set the Group ID. When the Group ID is set, the same Group ID is given to all the composition images and the still pictures obtained from a single exposure that are captured in accordance with a single pressing of the second shutter switch signal SW2.

S820 to S825 are the same processing as S319 to S324 of FIG. 3B.

In S826, the system control unit 50 compares the current number of times of image-capturing and the total number of times of image-capturing derived in S815. Then, when the number of times of image-capturing is less than the total number of times of image-capturing, S827 is subsequently performed, and the number of times of image-capturing is equal to or more than the total number of times of image-capturing, S830 is subsequently performed.

The processing in S827 is the same processing as S326 of FIG. 3C.

In S828, the system control unit 50 determines whether the digital camera 100 is moving or not (whether there is a possibility of occurrence of blur when exposure is performed) like S820. When the digital camera 100 is determined to be moving, S829 is subsequently performed, and when the digital camera 100 is determined not to be moving, S832 is subsequently performed.

In S829, the system control unit 50 gives a Group ID and In-Group numbers to the composite images composited in S836 and saved to the composition memory 403 as the image file, and records them to the recording medium 200 (a nonvolatile memory), and then returns back to S820. When the digital camera 100 is determined to be moving when only a single image is captured, the still picture saved in the composition memory 403 in S824 is recorded. This In-Group number is a number used to identify an image in a Group subsequent to the Group ID, and for example, a number subsequent to the Group ID is given such that the composition image given with an In-Group number first in S829 is given one, and the composition image subsequently given is given two.

In S830, the system control unit 50 displays a question 513 to ask a user whether to composite composition images given the same Group ID as shown in FIGS. 5D-1 and 5D-2 in S829. The selection items are also displayed so that the user can select an OK display 516 or a cancel display 517. On the display unit 28, multiple tracks which are to be composited in series-composition such as the track 514 and the track 515 in the composition image 535 of FIG. 5D-1 are shown as candidates, and a selection as to whether the tracks being displayed are to be composited in the series-composition is received while seeing multiple composition images displayed on the screen. In this case, the track 515 of the composition image 535 of FIG. 5D-1 is a track shown in the composition image of the In-Group number 1, and the track 514 is a track shown in the composition image of the In-Group number 2. When a selection is made to perform composition, S831 is subsequently performed, and when a selection is made not to perform composition, the processing of the starlit sky track is terminated. Further, when the composition image is generated in the series of image-capturing (when there is a track that is not already composited in series-composition), a candidate of a track (track 518) that is further composited in series-composition is shown as shown in the composition image 534 of FIG. 5D-2. The track 518 is a track shown in the composition image of the In-Group number 3. Then, a selection as to whether the candidate of the track displayed is composited in series-composition is received. As described above, when there are three or more composition images, a selection may be allowed to choose whether to composite each track with another track in the composition image having the same Group ID. Further, a selection may be allowed to choose whether to composite all the tracks in all the composition images having the same Group ID.

In S831, the system control unit 50 composites composition images in the same Group ID selected for composition in S830, and records the composition image to the recording medium 200.

S832 to S837 are the same processing as S329 to S334 of FIG. 3C.

In S838, the system control unit 50 compares the current number of times of image-capturing and the total number of times of image-capturing derived in S815. Then, when the number of times of image-capturing is less than the total number of times of image-capturing, S839 is subsequently performed, and the number of times of image-capturing is equal to or more than the total number of times of image-capturing, S828 is subsequently performed.

S839 to S840 are the same processing as S336 to S337 of FIG. 3C.

In S841, the system control unit 50 determines whether the second shutter switch signal SW2 is in the ON state due to full-press of the shutter button 61. When the second shutter switch signal SW2 is determined to be in the ON state, S830 is subsequently performed, and the second shutter switch signal SW2 is determined not to be in the ON state, S840 is performed again.

According to the processing explained above, in the series of image-capturing for letting the user capture images of a subject such as a starlit sky multiple times and compositing the image, the images are composited without including a captured image that is likely to be blurred, and therefore, a composition image which is less likely to be blurred can be obtained. The user can select whether to further composite composition images recorded in the recording medium 200 in the series of the processing of the starlit sky track. Therefore, the user can determine whether to obtain each of the composition images before and after the blur or to obtain a composition image obtained by compositing the composition images before and after the blur into the single composition image after the user sees the composition image. Further, by giving the same Group ID to multiple images captured in the series of starlit sky track, only the composition images in the same Group captured can be played back successively or as a list in response to the same image-capturing command during play back. Therefore, according to the present exemplary embodiment, in the image-capturing of the series of tracks, image-capturing of the tracks except a still picture that is likely to be blurred (composition of still pictures) and multiple composition images generated in the series of image-capturing can be composited in series-composition easily.

In the present exemplary embodiment, the tracks shown in the composition images in the order based on the In-Group numbers are shown as the candidates which are to be composited in the series-composition. Alternatively, regardless of the In-Group numbers, they may be shown as the candidates which are to be composited in the series-composition. For example, the first candidate of the track composited in the series-composition with another composition image in the same Group ID (any one of the tracks shown in the composition image 535 of FIG. 5D-1) may be a track in a composition image having the highest number of continuous image-capturing of still pictures included in the composition image. In the tracks 514, 515, 518 shown in the composition image 534 of FIG. 5D-2 and the composition image 535 of FIG. 5D-1, the track 514 is the longest, and is a track having the largest number of continuous image-capturing, and therefore, the track 514 is displayed as one of the first candidates which are to be composited in the series-composition.

### Modification Fourth Exemplary Embodiment

In the fourth exemplary embodiment, the case where the digital camera 100 moved (the case where a blur may occur) in the processing of the starlit sky track image-capturing has been explained with reference to the flow of image-capturing. However, the above flow can be applied in the same manner to the case where a change in the subject brightness or the color of the subject that is not acceptable to the user is detected. Even when the subject brightness or the color of the subject is detected, the example of the configuration of the digital camera in FIGS. 1 and 2, the flow diagrams in FIGS. 8A to 8C, the drawing of the image file in FIGS. 4A to 4C, and the figure of the captured image in FIGS. 5A-1 to 5D-2 are almost the same as those in the fourth exemplary embodiment for detecting blur. Different points will be hereinafter explained.

S820 of the present modification is the same processing as S319 of the modification of the first exemplary embodiment.

In S828 of the present modification, instead of the determination as to whether a blur is detected or not in the fourth exemplary embodiment, or together with the determination as to whether a blur is detected or not, the following processing is performed. The system control unit 50 measures the brightness or the color temperature, and determines whether the brightness has changed by one or more and the color temperature has changed by 1000 K or more than the brightness or the color temperature measured and recorded in S813. The subject brightness or the color of the subject is determined to have changed in a case where the brightness has changed by one or more (a predetermined value or more) or the color temperature has changed by 1000 K or more (a predetermined value or more). When it is determined that there is a change, S829 is subsequently performed. In a case where it is determined that there is no longer any change, the value of the brightness or the color temperature measured in S813 is erased from the memory 32, and the value of the brightness or the color temperature measured in S820 is stored to the memory 32.

According to the example explained above, composition is performed without including a captured image that may have a change in the subject brightness or the color of the subject, and therefore, a composition image which is less likely to involve a change in the subject brightness or the color of the subject can be obtained. In addition, the user can select whether to further composite composition images recorded in the recording medium 200 in the series of the image-capturing of the starlit sky track. Therefore, the user can determine whether to obtain each of the composition images before and after the change in the subject brightness or the color of the subject or to obtain a composition image obtained by compositing the composition images before and after the change in the subject brightness or the color of the subject into the single composition image after the user sees the composition image. Further, by giving the same Group ID to multiple images captured in the series of starlit sky track, only the composition images in the same Group captured can be played back successively or as a list in response to the same image-capturing command during play back. Therefore, according to the present exemplary embodiment, in the image-capturing of the series of tracks, image-capturing of the tracks except a still picture that is likely to involve the change in the subject brightness or the color of the subject (composition of still pictures) and multiple composition images generated in the series of image-capturing can be composited in series-composition easily.

In the first, third, and fourth exemplary embodiments, when the digital camera 100 is determined to be moving for a single time, a subsequent step is performed. Alternatively, when the digital camera 100 is determined to be moving a predetermined number of times or more such as three times and five times instead of a single time, a subsequent step may be performed. In this case, the number of times the digital camera 100 is determined to be moving is stored to the system memory 52, and when the number of times is more than a predetermined number of times, a subsequent step may be performed, and the predetermined number of times may be set in accordance with the accuracy desired by the user. Even when a change in the image-capturing range is detected based on the subject brightness or the color of the subject, a subsequent step may be performed when the change in the subject brightness and the color of the subject is detected a predetermined number of times like the case where a blur is detected.

In the present exemplary embodiment, a blur is detected when the digital camera 100 has moved with an angular velocity equal to or more than a predetermined value. Alternatively, a blur may be detected when the digital camera 100 has moved for a predetermined time or more with an angular velocity equal to or more than a predetermined value.

In a case where detection is performed on the basis of the subject brightness or the color of the subject, a change in the subject brightness or the color of the subject is determined to have occurred when a difference between the latest value of the brightness or the color temperature and the value measured before the immediately before image-capturing (the value stored in the memory 32) is a predetermined or more. However, when the brightness is detected to have changed by a predetermined value or more (a change is determined to have occurred) or the color temperature is detected to have changed by a predetermined value or more (a change is determined to have occurred) for a predetermined time or more, a change may be determined to have occurred in the subject brightness or the color of the subject.

In the first exemplary embodiment to the fourth exemplary embodiment and each modification thereof, the total image-capturing time is set, and the light measurement and distance measurement processing is performed when the SW1 is pressed down, whereby the image-capturing interval and the total number of times of image-capturing are calculated, but the present exemplary embodiment can also be applied even to a case where the image-capturing interval and the total number of times of image-capturing are set in advance. The image-capturing interval may be longer than a time obtained by adding a processing time for a single image-capturing processing (black image subtraction processing, composition processing) to the shutter speed (which is 20 seconds when the shutter speed is 10 seconds per image, and a time for the image-capturing processing is 10 seconds), and for example, it may be a length such as an interval of one day. In the first to fourth exemplary embodiments, the processing of the starlit sky track has been explained. The present disclosure is not limited to image-capturing of a subject such as a star, and can also be applied to recording of a light trace and a track including, for example, a track of a rotating Ferris wheel and image-capturing of a cruising vehicle. The subject may not be the same. Further, each exposure time for composition may not be constant throughout the series of image-capturing, and the image-capturing interval between image-capturing and image-capturing of still pictures for composition may also be set to a value different on each image-capturing. For example, when the user wants to capture an image of the movement of the same constellation every day, the image of the track of the constellation can be captured by slightly changing the timing of the image-capturing every day.

In the first to fourth exemplary embodiments, the digital camera 100 is used as an example of an image processing apparatus to which the present disclosure can be applied, and therefore, a determination is made as to whether the digital camera 100 is moving or not, but the first to fourth exemplary embodiments are not limited thereto. The hardware for controlling the image-capturing or the composition and the hardware of the image-capturing unit may be configured separately. The present disclosure is to determine whether a blur is likely to occur in a still picture to be captured in accordance with whether the image-capturing unit is moving or not, and therefore, when the image-capturing unit is determined to be moving, it is not necessary to determine whether the entire digital camera 100 is moving or not.

In the method of blur determination, the direction of time-series motion of the subject at various positions in the image-capturing range is detected as a motion vector, and when motion vectors of a predetermined number of subjects or more are changed in the same direction, the digital camera 100 itself may be determined to have moved.

When the motion vectors of the predetermined number of subjects or more are detected, not only the blur of the digital camera 100 but also the abnormality in the image-capturing range (the blur of the subject) are detected. More specifically, in the case of the processing of the starlit sky track, when a subject not intended for track image-capturing such as an airplane, a vehicle, a ship, a person, and an animal not expected by the user enters into the image-capturing range, the image of the track in which the non-intended subject is not included in the composition image can be captured.

In the explanation about the present exemplary embodiment, the blur of the digital camera 100 is detected, but what is included in the composition image as the blur is not limited to the subject which the user adopts as the image-capturing target of the track. When light from an airplane, a vehicle, a ship, a person, an animal, and the like, and light from the vicinity of the image-capturing range come into the image-capturing range, the blur generated when the non-intended subject moves in a short time may be included in the composition image, and a change in the subject brightness or the color of the subject may be included in the composition image.

In this explanation, the blur of the digital camera 100, the subject brightness, and the color of the subject are measured, so that those that are not acceptable to the user are excluded from the image-capturing range, but the embodiments are not limited thereto. More specifically, it is effective to detect those satisfying a predetermined condition that may affect the image-capturing range such as a detection of wind, analysis of a through image, and a change of sound.

In the explanation about the present exemplary embodiment, the processing after the detection of the blur has been explained. But the present disclosure is also effective in a case where a blur is detected in the step of still picture image-capturing (exposure). When a blur is detected during exposure, the exposure may be interrupted at that point, and then, a subsequent step of each exemplary embodiment may be performed, or a previous step of each exemplary embodiment (a step of determining detection of a blur) may be performed again. Alternatively, it is possible to wait until a period of time for exposure elapses, and then, the exposure may be performed again, and then, a subsequent step of each exemplary embodiment may be performed, or a previous step of each exemplary embodiment (a step of determining detection of a blur) may be performed again.

In the present exemplary embodiment, the track of the period of time determined to involve a change in the subject brightness or the color of the subject or that the digital camera 100 is moving is excluded from the composition image. However, the track in the excluded portion may be interpolated so that the end point of the track before the blur detection and the start point of the track after the blur detection are connected. The interpolation is done by copying the track in the composition image and compositing the track into the portion where the track is excluded.

In a case where a change in the subject brightness or the color of the subject is detected, comparison is performed with the value (the value stored in the memory 32) measured before the image-capturing that is done immediately before. Alternatively, the subject brightness or the color of the subject may be measured with a regular interval, and the value immediately before may be compared. In this case, a change in the image-capturing range and a blur in the composition image are detected by detecting any one of the blur, a change of the subject brightness, and a change of the color of the subject, but the embodiments are not limited thereto. Detection can be performed by combining two or all of the blur, the subject brightness, and the color of the subject. When detection is performed with multiple parameters, processing may be performed in accordance with detection of any one of multiple parameters, or processing may be performed in accordance with detection of all of the parameters. The image processing apparatus may be controlled by a piece of hardware, or processing may be distributed to multiple pieces of hardware, so that the control of the entire apparatus may be performed.

In the explanation about the present exemplary embodiment, image-capturing is performed multiple times in accordance with a single image-capturing command. However, the present disclosure is not limited thereto. The present disclosure is also effective when image-capturing is performed multiple times in accordance with different image-capturing commands, whereby a track is generated. For example, the present disclosure is applicable even to a case where multiple images captured every time the user gives an image-capturing command may be generated as a track.

The present disclosure has been explained in details with reference to preferred exemplary embodiments thereof, but the present disclosure is not limited to these particular exemplary embodiments. Various aspects in a range without deviating from the gist of this disclosure are also included in the present disclosure. Further, each of the exemplary embodiments explained above only indicates an embodiment of the present disclosure, and the exemplary embodiment can be combined as necessary.

Each of the exemplary embodiments explained above has been explained using an example where the present disclosure is applied to the digital camera 100, but the exemplary embodiments explained above are not limited to this example. More specifically, the present disclosure can be applied to any electronic device as long as the electronic device performs image processing. Further, the present disclosure can be applied to any apparatus capable of performing image-capturing such as a PDA (personal digital assistant), a cellular phone terminal, a printer apparatus having a portable image-capturing unit, a digital photo frame, a music player, a game machine, and an electronic book reader.

### Other Exemplary Embodiments

The present disclosure can also be achieved by executing the following processing. More specifically, this is such processing that computer executable instructions (e.g., one or more programs) recorded on a storage medium (which may also be referred to more fully as a ‘non-transitory computer-readable storage medium’) to perform the functions of the above-described embodiments and/or that includes one or more circuits (e.g., application specific integrated circuit (ASIC)) for performing the functions of the above-described embodiments is provided to a system or an apparatus via a network or various kinds of storage media, and a computer (or a central processing unit (CPU), a micro processing unit (MPU), or the like) of the system or the apparatus reads the program code and executes the computer executable instructions (e.g., one or more programs) recorded on a storage medium (which may also be referred to more fully as a ‘non-transitory computer-readable storage medium’. In this case, the program and the storage medium storing the program constitute the present disclosure.

According to the present disclosure, even in a case where a change that is not desired by a user occurs in the middle of the image-capturing that is performed multiple times, the possibility of causing an effect in a composition image that is not acceptable to the user can be reduced.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2014-120000, filed Jun. 10, 2014, which is hereby incorporated by reference herein in its entirety.

What is claimed is:

1. An image processing apparatus comprising:
an obtaining unit configured to obtain information indicating detection of a blur of an image-capturing apparatus, a change in a subject brightness, or a change in a color of a subject;
an image-capturing control unit configured to perform control so that the image-capturing apparatus performs image-capturing a plurality of times in accordance with a single image-capturing command;
a composite unit configured to composite a plurality of images captured in accordance with the single image-capturing command; and
a control unit configured such that when the control unit obtains information indicating that a predetermined blur, a change in a predetermined subject brightness, or a change in a color of a predetermined subject is detected based on a result obtained by the obtaining unit, the control unit controls the composite unit so as to generate a composition image made by compositing a plurality of images captured before detection without including an image captured after detection.

2. The image processing apparatus according to claim 1, further comprising a detection unit configured to detect a blur of an image-capturing apparatus, a change in a subject brightness, or a change in a color of a subject,
wherein the obtaining unit obtains information indicating that a blur of an image-capturing apparatus, a change in a subject brightness, or a change in a color of a subject is detected based on a detection result of the detection unit.

3. The image processing apparatus according to claim 1, wherein the control unit controls the composite unit so as to composite a plurality of images captured after the predetermined blur, the change in the predetermined subject brightness, or the change in the color of the predetermined subject is detected, in a separate manner from the composition image made by compositing a plurality of images captured before the detection.

4. The image processing apparatus according to claim 3, further comprising a series-composition unit configured to further composite a plurality of composition images when the plurality of composition images are generated in accordance with the single image-capturing command.

5. The image processing apparatus according to claim 3, wherein the control unit further gives a same identifier to a plurality of composition images made by compositing images captured in response to a same image-capturing command among images captured in response to the single image-capturing command.

6. The image processing apparatus according to claim 1,
wherein the control unit performs control so that image-capturing is not performed while the predetermined blur, the change in the predetermined subject brightness, or the change in the color of the predetermined subject is detected, and image-capturing is started when the predetermined blur, the change in the predetermined subject brightness, or the change in the color of the predetermined subject is no longer detected.

7. The image processing apparatus according to claim 1,
wherein the control unit performs control so as to perform composition without including an image captured while the predetermined blur, the change in the predetermined subject brightness, or the change in the color of the predetermined subject is detected.

8. The image processing apparatus according to claim 1, wherein the control unit performs control so that a blur is detected when the image-capturing apparatus moves by a predetermined level or more, and a change in a brightness or a change in a color is detected when the color of the subject brightness or the subject changes by a predetermined level or more.

9. The image processing apparatus according to claim 1, wherein the control unit performs control so that a blur is detected when the image-capturing apparatus moves a predetermined number of times or more, and a change in a brightness or a change in a color is detected when the color of the subject or brightness of the subject changes a predetermined number of times or more.

10. The image processing apparatus according to claim 1, wherein the composition is a multiplex composition for compositing a plurality of images in an overlapping manner.

11. The image processing apparatus according to claim 10, wherein the multiplex composition is any one of a relatively brighter composition or a relatively darker composition.

12. The image processing apparatus according to claim 1, wherein the control unit performs control so as to perform image-capturing a plurality of number of times with a predetermined image-capturing interval in accordance with the single image-capturing command.

13. An image processing apparatus comprising:
a detection unit configured to detect a blur of an image-capturing apparatus, a change in a subject brightness, or a change in a color of a subject;
an image-capturing control unit configured to perform control so that the image-capturing apparatus performs image-capturing a plurality of times in accordance with a single image-capturing command;
a composite unit configured to composite a plurality of images captured in accordance with the single image-capturing command; and
a control unit configured such that when the control unit detects a predetermined blur, a change in a predetermined subject brightness, or a change in a color of a predetermined subject based on a detection result obtained by the obtaining unit, the control unit controls the image-capturing control unit so as not to perform image-capturing during detection of a blur by the detection unit and controls the image-capturing control unit so as to perform image-capturing when the detection is no longer made, and controls the composite unit so as to generate a composition image made by compositing a plurality of images including an image captured before the detection and an image captured after the detection.

14. The image processing apparatus according to claim 13, wherein the control unit controls the composite unit to composite a predetermined number of images including an image captured before the detection and an image captured after the detection.

15. An image processing apparatus comprising:
a detection unit configured to detect a blur of an image-capturing apparatus, a change in a subject brightness, or a change in a color of a subject;
an image-capturing control unit configured to perform control so that the image-capturing apparatus performs image-capturing a plurality of times in accordance with a single image-capturing command;
a composite unit configured to composite a plurality of images captured in accordance with the single image-capturing command; and
a control unit configured such that when the control unit detects a predetermined blur, a change in a predetermined subject brightness, or a change in a color of a predetermined subject based on a detection result obtained by the obtaining unit, the control unit controls the composite unit so as to separately generate a composition image made by compositing a plurality of images not including an image captured during the detection and a composition image made by compositing a plurality of images including an image captured during the detection.

16. The image processing apparatus according to claim 15, wherein the control unit displays, on a display unit, a composition image made by compositing a plurality of images including an image captured during the detection together with information indicating a blur, a change in a subject brightness, or a change in a color of a subject.

17. A control method for an image processing apparatus, the method comprising:
an obtaining step of obtaining information indicating detection of a blur of an image-capturing apparatus, a change in a subject brightness, or a change in a color of a subject;
an image-capturing control step of performing control so that the image-capturing apparatus performs image-capturing a plurality of times in accordance with a single image-capturing command;
a composite step of compositing a plurality of images captured in accordance with the single image-capturing command; and
a control step in which when information indicating that a predetermined blur, a change in a predetermined subject brightness, or a change in a color of a predetermined subject is detected is obtained based on a result obtained in the obtaining step, control is performed so as to generate a composition image made by compositing a plurality of images captured before the detection without including an image captured after the detection.

18. A control method for an image processing apparatus, the method comprising:
a detection step of detecting a blur of an image-capturing apparatus, a change in a subject brightness, or a change in a color of a subject;
an image-capturing control step of performing control so that the image-capturing apparatus performs image-capturing a plurality of times in accordance with a single image-capturing command;
a composite step of compositing a plurality of images captured in accordance with the single image-capturing command; and
a control step in which when a predetermined blur, a change in a predetermined subject brightness, or a change in a color of a predetermined subject is detected based on a detection result obtained in the detection step, control is performed so as not to perform image-capturing during detection of a blur in the detection step and so as to perform image-capturing when the detection is no longer made, and control is performed so as to generate a composition image made by compositing a plurality of images including an image captured before the detection and an image captured after the detection.

19. A control method for an image processing apparatus, the method comprising:
a detection step of detecting a blur of an image-capturing apparatus, a change in a subject brightness, or a change in a color of a subject;
an image-capturing control step of performing control so that the image-capturing apparatus performs image-capturing a plurality of times in accordance with a single image-capturing command;
a composite step of compositing a plurality of images captured in accordance with the single image-capturing command; and
a control step in which when a predetermined blur, a change in a predetermined subject brightness, or a change in a color of a predetermined subject is detected based on a detection result obtained in the detection step, control is performed so as to separately generate a composition image made by compositing a plurality of images not including an image captured during the detection and a composition image made by compositing a plurality of images including an image captured during the detection.

20. A non-transitory computer-readable recording medium storing a program causing a computer to execute the method according to claim 17.

21. A non-transitory computer-readable recording medium storing a program causing a computer to execute the method according to claim 18.

22. A non-transitory computer-readable recording medium storing a program causing a computer to execute the method according to claim 19.
